(19) United States
(12) Patent Application Publication
(10) Pub. No.: US 2023/0206321 A1
(43) Pub. Date: Jun. 29, 2023

(54) INFORMATION PROCESSING APPARATUS, INFORMATION PROCESSING SYSTEM, AND INFORMATION PROCESSING METHOD

(71) Applicant: Kazuki OHARA, Kanagawa (JP)

(72) Inventor: Kazuki OHARA, Kanagawa (JP)

(21) Appl. No.: 18/085,612

(22) Filed: Dec. 21, 2022

(30) Foreign Application Priority Data
Dec. 23, 2021 (JP) 2021-209517

(51) Int. Cl. G06Q 40/03

(52) U.S. Cl. CPC G06Q 40/03

(57) ABSTRACT

An information processing apparatus includes: circuitry configured to in response to a request from a user terminal of a first user, obtain a collection status indicating whether collection of an item from a second user to the first user has been completed, determine, for the item having a collection status indicating uncompleted transfer, an action to be taken by the first user to collect the item, and transmit screen data to the user terminal of the first user, the screen data for displaying a proposal screen including the action to be taken by the first user for selection by the first user.

### CROSS-REFERENCE TO RELATED APPLICATIONS

This patent application is based on and claims priority pursuant to 35 U.S.C. § 119(a) to Japanese Patent Application No. 2021-209517, filed on Dec. 23, 2021, in the Japan Patent Office, the entire disclosure of which is hereby incorporated by reference herein.

### BACKGROUND

### Technical Field

The present invention relates to an information processing apparatus, an information processing system, an information processing method, and a recording medium.

### Related Art

There is a system that provides a service to a user, in response to a request from the user. In some cases, it is difficult for the user to determine whether to request for such service.

### SUMMARY

Example embodiments include an information processing apparatus including circuitry that, in response to a request from a user terminal of a first user, obtains a collection status indicating whether collection of an item from a second user to the first user has been completed, determines, for the item having a collection status indicating uncompleted transfer, an action to be taken by the first user to collect the item, and transmits screen data to the user terminal of the first user, the screen data for displaying a proposal screen including the action to be taken by the first user for selection by the first user.

Example embodiments include an information processing system including circuitry that, in response to a request from a user terminal of a first user, obtain a collection status indicating whether collection of an item from a second user to the first user has been completed, determines, for the item having a collection status indicating uncompleted transfer, an action to be taken by the first user to collect the item, and displays, on a display, a proposal screen including the action to be taken by the first user for selection by the first user.

Example embodiments include an information processing method including, in response to a request from a user terminal of a first user, obtaining a collection status indicating whether collection of an item from a second user to the first user has been completed, determining, for the item having a collection status indicating uncompleted transfer, an action to be taken by the first user to collect the item, and transmitting screen data to the user terminal of the first user, the screen data for displaying a proposal screen including the action to be taken by the first user for selection by the first user.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an overall configuration of an information processing system according to embodiments;

FIG. 2 is a block diagram illustrating an example of a hardware configuration of an information processing apparatus according to embodiments:

FIG. 3 is a diagram illustrating relationships between companies according to embodiments:

FIG. 4 is a block diagram illustrating an example of a functional configuration of the information processing system according to embodiments:

FIG. 5 is a conceptual diagram illustrating an example customer information table;

FIG. 6 is a conceptual diagram illustrating an example invoice information table:

FIG. 7 is a conceptual diagram illustrating an example account transfer application table;

FIG. 8 is a conceptual diagram illustrating an example invoice information table;

FIG. 9 is a conceptual diagram illustrating an example debt guarantee information table;

FIG. 10 is a conceptual diagram illustrating an example fulfillment information table:

FIG. 11 is a conceptual diagram illustrating an example debt management information table:

FIG. 12 is a conceptual diagram illustrating an example credit information table;

FIGS. 13A and 13B (FIG. 13) are a conceptual diagram illustrating an example transaction history information table:

FIG. 14 is a sequence diagram illustrating example account transfer processing according to the embodiment;

FIG. 15 is a sequence diagram illustrating example information collection processing according to the embodiment:

FIG. 16 is a sequence diagram illustrating example proposal processing according to the embodiment;

FIG. 17 is a diagram illustrating an example of a debt list screen according to the embodiment;

FIG. 18 is a flowchart illustrating an example of action determination processing;

FIG. 19 is an illustration of an example of a proposal screen according to the embodiment;

FIG. 20 is an illustration of an example of a setting screen according to the embodiment;

FIG. 21 is a sequence diagram illustrating an example of proposal processing according to the modified example;

FIG. 22 is a diagram illustrating an example of action determination processing according to the modified example:

FIGS. 23A and 23B (FIG. 23) are an illustration of an example of a proposal screen and a guide screen according to the modified example; and

FIGS. 24A and 24B (FIG. 24) are an illustration of an example of a proposal screen and a guide screen according to the modified example.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### DETAILED DESCRIPTION OF THE INVENTION

Hereinafter, embodiments of the present invention will be described in detail with reference to the drawings. In the drawings, components having the same functions are denoted by the same reference numerals, and redundant description will be omitted.

Overall Configuration of Information Processing System

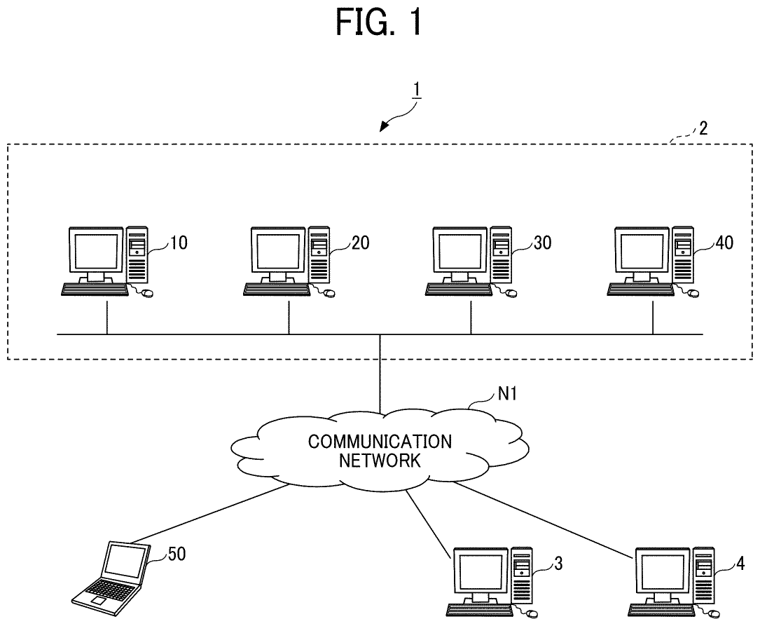

Referring to FIG. 1, the overall configuration of an information processing system is described according to the one or more embodiments. FIG. 1 is a block diagram illustrating an example of an overall configuration of the information processing system according to the one or more embodiments.

As illustrated in FIG. 1, the information processing system 1 of the embodiments includes a transaction management system 2, an account transfer system 3, a debt guarantee system 4, and a user terminal 50. The transaction management system 2 in the embodiments includes a form management server 10, an account transfer server 20, a debt guarantee server 30, and a debt management server 40. Each of the systems, servers and terminals included in the information processing system 1 is connected to a communication network N1.

Through the communication network N1, the devices can communicate with each other. The communication network N1 is implemented by, for example, a wired communication network such as the Internet, a local area network (LAN), or a wide area network (WAN). The communication network N1 may include not only wired communication network, but also a wireless communication network such as a wireless local area network (LAN) or a short-range wireless communication network, or a mobile communication network based on such as worldwide interoperability for microwave access (WiMAX), long term evolution (LTE), or 5th (5G) generation.

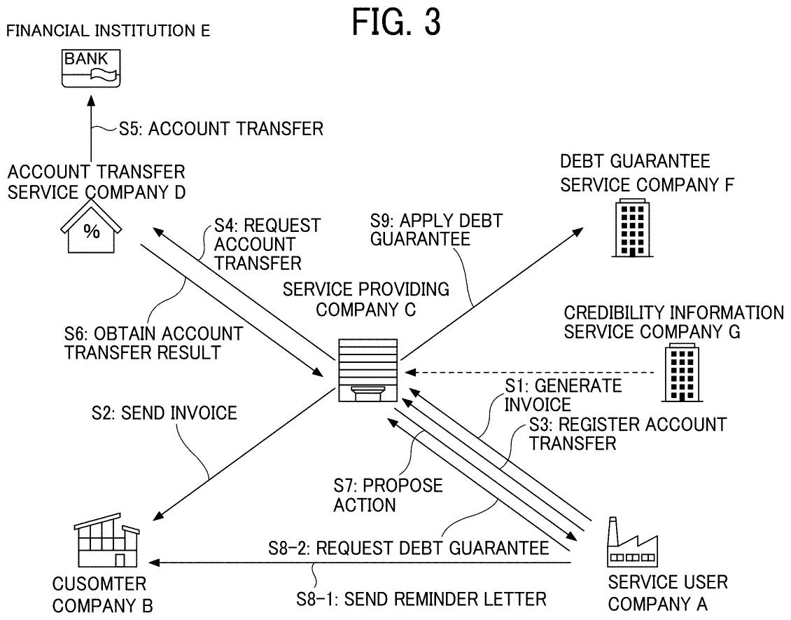

In this disclosure, the information processing system of FIG. 1 is used in an environment described below referring to FIG. 3.

Relationships Between Companies

Referring to FIG. 3, the relationships between companies, which are examples of entities, will be described according to embodiments. FIG. 3 is a diagram illustrating relationships between companies according to the embodiments.

As illustrated in FIG. 3, a service user company A is a company that provides goods or services to a business partner company B, and receives compensation for the goods or services from the business partner company B. The business partner company B is a business partner of the service user company A. In this case, the service user company A is a creditor and the business partner company B is a debtor. For example, the business partner company B may be a customer of the service user company A, or a buyer of the goods or services provided by the service user company A. In the following, the business partner company B is referred to as the customer company B.

The service providing company C is a company that provides a service for managing a series of procedures in relation to a transaction with the customer company B, in response to a request from the service user company A. The service user company that uses a service provided by an information processing system 1 (see FIG. 1) according to the one or more embodiments to be described below may be referred to as a tenant. The tenant in this disclosure is a business operator, an organization, an individual, etc. In the following, the service provided by the service providing company C may be referred to as a “transaction management service”. The series of procedures in relation to transaction includes, for example, issuing an invoice (bill), sending the invoice to a customer, collecting debt by account transfer, and providing guarantee coverage for uncollected debt.

In this disclosure, debt is an example of item to be collected by the user at the service user company A (example of first user) from the customer company B (example of second user).

The account transfer service company D is a company that cooperates with the service providing company C to provide a service for performing a procedure necessary for debt collection by account transfer on behalf of the service providing company C. In the following, the service provided by the account transfer service company D may be referred to as an “account transfer service”. Typically, in the account transfer service, account transfer requests that have been applied by a preset closing date are processed on a preset transfer date at once. For simplicity, it is assumed that the account transfer service in this disclosure performs account transfer once every month.

The financial institution E is an entity, such as a company or an organization, which manages accounts respectively owned by the service user company A and the customer company B. In response to the request from the account transfer service company D, the financial institution E transfers a certain amount of money from the account of the customer company B to the account of the service user company A.

The debt guarantee service company F is a company that cooperates with the service providing company C to provide a service for paying an insurance money for debt that cannot be collected. In the following, the service provided by the debt guarantee service company F may be referred to as a “debt guarantee service”.

The credit information service company G is a company that provides credit information to the service providing company C. The credit information service company G has credit information of various companies, such as the customer company B, for evaluating credibility of the company. The credit information service company G may be one company or a plurality of companies. In a case where the debt guarantee service company F has credit information, the debt guarantee service company F may provide the credit information to the service providing company C. Further, the service providing company C may independently calculate the credibility based on information on management of the customer company B collected by the service providing company C. The credibility can be calculated using, for example, a machine learning model trained with information related to management of various companies.

The following describes an outline of transactions, performed by the entities of FIG. 3, according to the embodiments.

First, the service user company A requests the service providing company C to create an invoice based on a transaction with the customer company B and send the created invoice to the customer company B (S1). The service providing company C creates the invoice and sends the invoice to the customer company B (S2).

Next, the service user company A requests the service providing company C to register account transfer information based on the invoice issued by the service user company A (S3). The service providing company C registers the account transfer information and requests the account transfer service company D to process account transfer (S4).

Subsequently, the account transfer service company D sends a particular form, such as a transfer form or a payment slip, for requesting transfer of money from one account to another account to the financial institution E. The account transfer service company D may send payment data for requesting account transfer to the financial institution E. The financial institution E processes account transfer, so as to transfer an amount of money by account transfer, as indicated by, for example, the payment slip or the payment data, on the designated transfer date (S5). It is assumed that the account transfer service company D has previously submitted an application form for handling account transfer for the customer company B to the financial institution E.

Next, the service providing company C acquires a result of the account transfer from the account transfer service company D (S6). In response to a request from the service user company A, the service providing company C proposes an action for collecting uncollected debt (also referred to as a “debt collection”) (S7).

The service user company A determines to perform the debt collection, and performs the debt collection. For example, the service user company A sends a reminder letter to the customer company B to request payment (S8-1). Alternatively, the service providing company C may send a reminder to the customer company B in response to a request from the service user company A. Additionally or alternatively, for example, the service user company A requests the service providing company C to provide debt guarantee service (S8-2). In response to the request for debt guarantee, the service providing company C requests the debt guarantee service company F to provide the debt guarantee service (S9).

In this disclosure, the debt collection is an option, which can be taken by the service user company A, based on proposal by the service providing company C. For example, as the option that the service user company A can take, the service user company A may decide not to take a specific action at the present time but simply to observe.

It has been difficult for the user at the service user company A to determine an action to take to collect uncollected debt. For example, when there is a plurality of uncollected debts, the user is required to select which one should be given priority to request for debt guarantee service. It could be sometimes difficult to just decide based on whether or not payment has not received from a customer by the payment due date. In view of this, in this disclosure, the service providing company C provides a service to propose an action for collecting uncollected debt.

Referring back to FIG. 1, how the information processing system 1 is implemented is described.

The user terminal 50 is provided at the service user company A. The transaction management system 2 is provided at the service providing company C. The account transfer system 3 is provided at the account transfer service company D. The debt guarantee system 4 is provided at the debt guarantee service company F.

The form management server 10 provides a form management service to the user terminal 50 via the communication network N1. The form management service according to the embodiments is a service for creating an invoice in response to a request from the user terminal 50 and sending the created invoice to a customer of the service user company A, such as the customer company B.

The account transfer server 20 provides an account transfer intermediary service to the user terminal 50 via the communication network N1. The account transfer intermediary service according to the embodiments is a service for carrying out a procedure for collecting debt by account transfer, with the account transfer system 3, in response to a request from the user terminal 50.

The debt guarantee server 30 provides a debt guarantee intermediary service to the user terminal 50 via the communication network N1. The debt guarantee intermediary service according to the embodiments is a service for carrying out a procedure to provide debt guarantee service for an uncollected debt, with the debt guarantee system 4, in response to a request from the user terminal 50.

The debt management server 40 provides a debt management service to the user terminal 50 via the communication network N1. The debt management service according to the embodiments is a service for managing a debt collection status, and if necessary, performing debt collection to collect debt in response to a request from the user terminal 50.

The user terminal 50 is an information processing apparatus used by a user. The user is, for example, an employee of the service user company A. The user terminal 50 uses various services provided by the respective servers in the transaction management system 2 via the communication network N1 in response to an operation by the user.

The form management server 10, the account transfer server 20, the debt guarantee server 30, the debt management server 40, and the user terminal 50 may each be implemented by an information processing apparatus. The form management server 10, the account transfer server 20, the debt guarantee server 30, the debt management server 40, and the user terminal 50 are each not limited to the information processing apparatus, such that any apparatus having a communication function may be used.

The form management server 10, the account transfer server 20, the debt guarantee server 30, the debt management server 40, and the user terminal 50 may each be implemented by, for example, a PJ (Projector), an IWB (Interactive White Board: Electronic whiteboard capable of mutual communication), an output device such as a digital signage, a head-up display (HUD), an industrial machine, an imaging device, a sound collection device, a medical device, a network home appliance, a connected car, a notebook personal computer (PC), a mobile phone, a smartphone, a tablet terminal, a game machine, a personal digital assistant (PDA), a digital camera, a wearable PC, a desktop PC, etc.

Hardware Configuration of Information Processing System

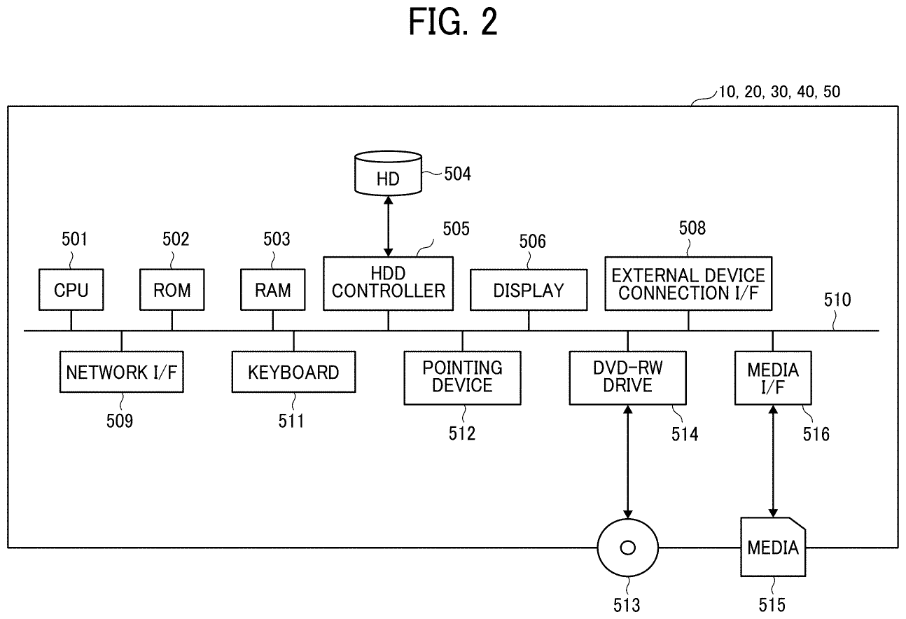

Referring to FIG. 2, a hardware configuration of the information processing system is described according to the embodiments. FIG. 2 is a diagram illustrating an example of a hardware configuration in a case where the form management server 10, the account transfer server 20, the debt guarantee server 30, the debt management server 40, and the user terminal 50 are each implemented by a computer.

As illustrated in FIG. 2, the computer includes a central processing unit (CPU) 501, a read only memory (ROM) 502, a random access memory (RAM) 503, a hard disk (HD) 504, a hard disk drive (HDD) controller 505, a display 506, an external device connection interface (I/F) 508, a network UF 509, a bus line 510, a keyboard 511, a pointing device 512, a digital versatile disk rewritable (DVD-RW) drive 514, and a medium (media) UF 516.

The CPU 501 controls entire operation of the computer. The ROM 502 stores a program for executing the CPU 501 such as an initial program loader (IPL). The RAM 503 is used as a work area for the CPU 501. The HD 504 stores various data such as a control program. The HDD controller 505 controls reading or writing of various data from or to the HD 504 under control of the CPU 501.

The display 506 displays various information such as a cursor, menu, window, character, and image. The external device connection UF 508 is an interface for connecting the computer to various external devices. Examples of the external devices include, but not limited to, a universal serial bus (USB) memory and a printer. The network IF 509 is an interface that controls communication of data with an external device through the communication network N1. The bus line 510 is, for example, an address bus or a data bus, which electrically connects the elements such as the CPU 501 illustrated in FIG. 2.

The keyboard 511 is one example of an input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 controls reading and writing of various data from and to a DVD-RW 513, which is an example of a removable recording medium. In alternative to the DVD-RW, any recording medium may be used such as a DVD-R, Blu-ray Disc (Registered Trademark), etc. The medium UF 516 controls reading and writing (storing) of data from and to a recording medium (media) 515 such as a flash memory.

Functional Configuration of Information Processing System

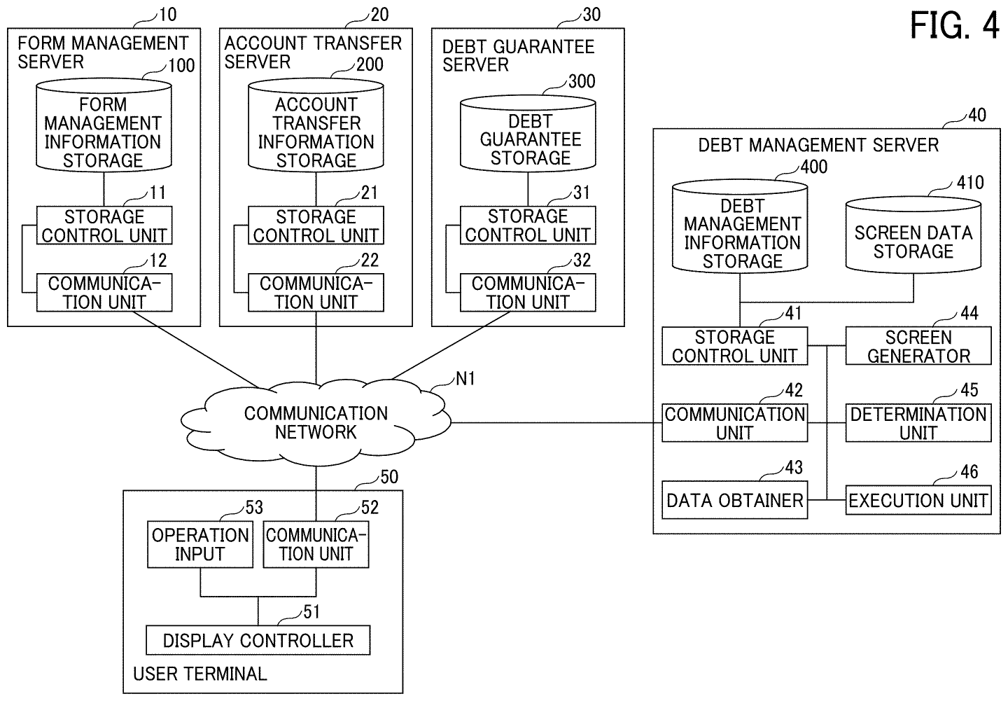

Referring to FIGS. 4 to 14, a functional configuration of the information processing system is described according to the embodiments. FIG. 4 is a block diagram illustrating an example of a functional configuration of the information processing system 1 according to the one or more embodiments.

Functional Configuration of Form Management Server

As illustrated in FIG. 4, the form management server 10 according to the embodiments includes a form management information storage 100, a storage control unit 11, and a communication unit 12.

The form management information storage 100 stores customer information and invoice information used in the form management service. The form management information storage 100 is implemented by, for example, the HD 504 illustrated in FIG. 2.

The storage control unit 11 writes and reads data to and from the form management information storage 10. The storage control unit 11 is implemented by, for example, processing performed by the CPU 501 and the HDD controller 505 according to a program loaded from the HD 504 onto the RAM 503, of which elements are illustrated in FIG. 2.

The communication unit 12 transmits and receives various types of information to and from other servers, devices, or systems via the communication network N1. The communication unit 12 is implemented by, for example, processing executed by the CPU 501 and the network I/F 509 according to a program loaded from the HD 504 onto the RAM 503, as illustrated in FIG. 2.

Customer Information Table

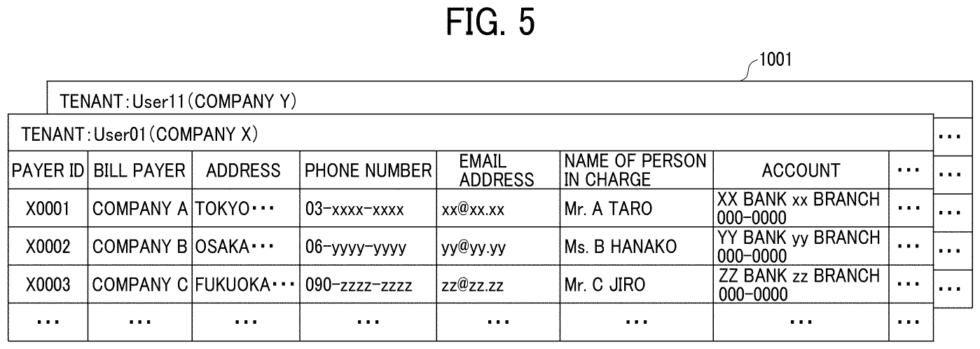

FIG. 5 is a conceptual diagram illustrating an example customer information table that stores customer information. The form management information storage 100 stores a customer information management DB 1001, implemented by the customer information table as illustrated in FIG. 5. The customer information table stores information regarding the customer company B, which is a customer of the service user company A.

As illustrated in FIG. 5, the customer information table stores, for each tenant, a bill payer ID, a bill payer name (company name, etc.), a bill payer address (location), a bill payer contact (telephone number, email address, etc.), a bill payer's name of a person in charge, and bill payer account information (bank name, branch name, account type, account number, account holder name, etc.) in association with one another.

Invoice Information Table

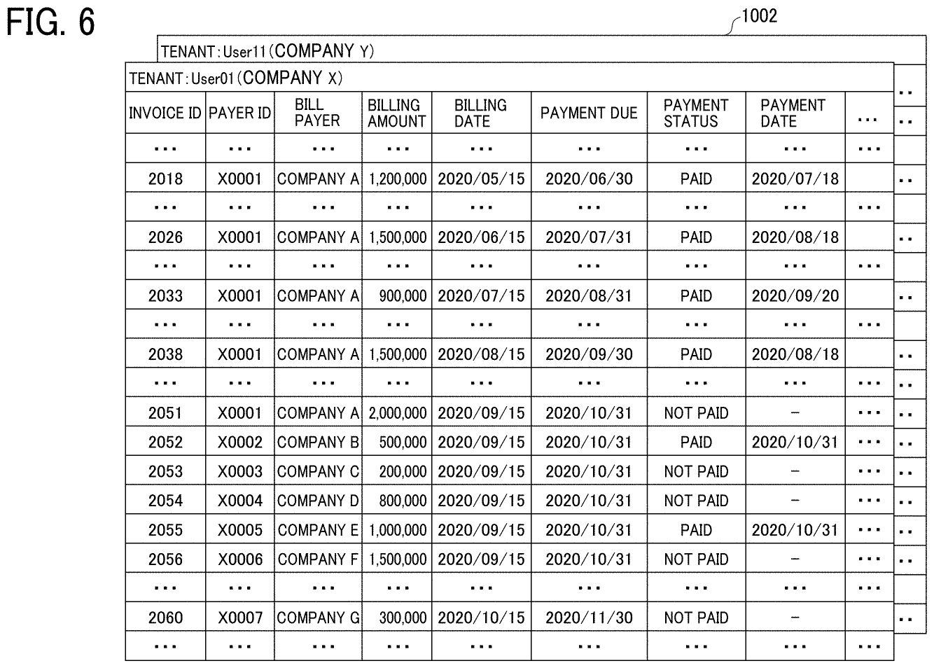

FIG. 6 is a conceptual diagram illustrating an example invoice information table that stores invoice information. The form management information storage 100 stores an invoice information management DB 1002, implemented by the invoice information table as illustrated in FIG. 6. The invoice information table stores information on invoices issued by the service user company A.

As illustrated in FIG. 6, the invoice information table stores, for each tenant, an invoice ID, a bill payer ID, a bill payer name (for example, company name), a billing amount, a billing date, a payment due date, a payment status (not paid or paid), a payment date, etc. in association with one another. The payment status is set to “not paid” when the invoice is issued in the form management service, and is set to “paid” when a deposit (payment) is confirmed.

Functional Configuration of Account Transfer Server

As illustrated in FIG. 4, the account transfer server 20 according to the embodiments includes an account transfer information storage 200, a storage control unit 21, and a communication unit 22.

The account transfer information storage 200 stores account transfer application information and account transfer information used in the account transfer intermediary service. The account transfer information storage 200 is implemented by, for example, the HD 504 illustrated in FIG. 2.

The storage control unit 21 writes and reads data to and from the account transfer information storage 200. The storage control unit 21 is implemented by, for example, processing performed by the CPU 501 and the HDD controller 505 according to a program loaded from the HD 504 onto the RAM 503, of which elements are illustrated in FIG. 2.

The communication unit 22 transmits and receives various types of information to and from other servers, devices, or systems via the communication network N1. The communication unit 22 is implemented by, for example, processing executed by the CPU 501 and the network I/F 509 according to a program loaded from the HD 504 onto the RAM 503, as illustrated in FIG. 2.

Account Transfer Application Table

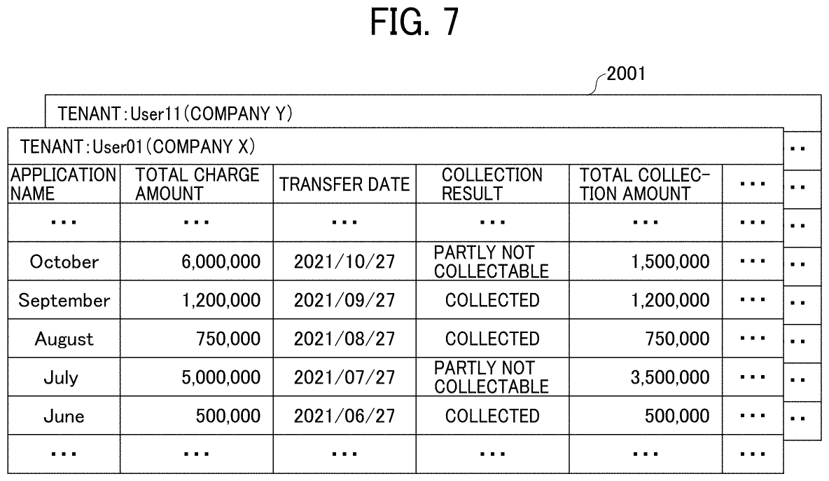

FIG. 7 is a conceptual diagram illustrating an example of an account transfer application table that stores account transfer application information. The account transfer information storage 200 stores an account transfer application management DB 2001, implemented by the account transfer application table as illustrated in FIG. 7. The account transfer application table stores information on an account transfer application requested by the service user company A.

As illustrated in FIG. 7, the account transfer application table stores, for each tenant, an application name representing an account transfer application, a total charge amount, a transfer date, a collection result (collected, partly not collectable, or uncollectable), a total collection amount, etc. in association with one another. The “collected” means a status in which all account transfers requested by application are completed. The “partly not collectable” means a status in which an uncompleted account transfer is present of account transfers applied. The “uncollectable” means a status in which all account transfers requested by application are uncompleted.

Account Transfer Information Table

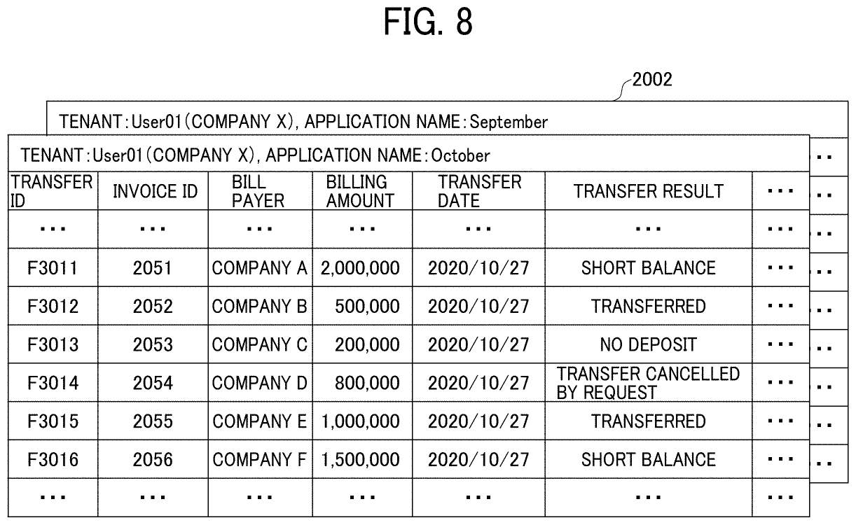

FIG. 8 is a conceptual diagram illustrating an example of an account transfer information table that stores account transfer information. The account transfer information storage 200 stores an account transfer information management DB 2002, implemented by the account transfer information table as illustrated in FIG. 8. The account transfer information table stores information on account transfer for each account transfer application requested by the service user company A.

As illustrated in FIG. 8, the account transfer information table stores, for each tenant and each account transfer application, a transfer ID, an invoice ID, a name of a bill payer (for example, company name), a billing amount, a transfer date, and a transfer result (transfer completed or not completed, if not completed, the reason therefor) in association with one another.

Functional Configuration of Debt Guarantee Server

As illustrated in FIG. 4, the debt guarantee server 30 according to the embodiments includes a debt guarantee information storage 300, a storage control unit 31, and a communication unit 32.

The debt guarantee information storage 300 stores debt guarantee information and fulfillment information used in the debt guarantee intermediary service. The debt guarantee information storage 300 is implemented by the HD 504 illustrated in FIG. 2, for example.

The storage control unit 31 writes and reads data to and from the debt guarantee information storage 300. The storage control unit 31 is implemented by, for example, processing performed by the CPU 501 and the HDD controller 505 according to a program loaded from the HD 504 onto the RAM 503, of which elements are illustrated in FIG. 2.

The communication unit 32 transmits and receives various types of information to and from other servers, devices, or systems via the communication network N1. The communication unit 32 is implemented by, for example, processing executed by the CPU 501 and the network I/F 509 according to a program loaded from the HD 504 onto the RAM 503, as illustrated in FIG. 2.

Debt Guarantee Information Table

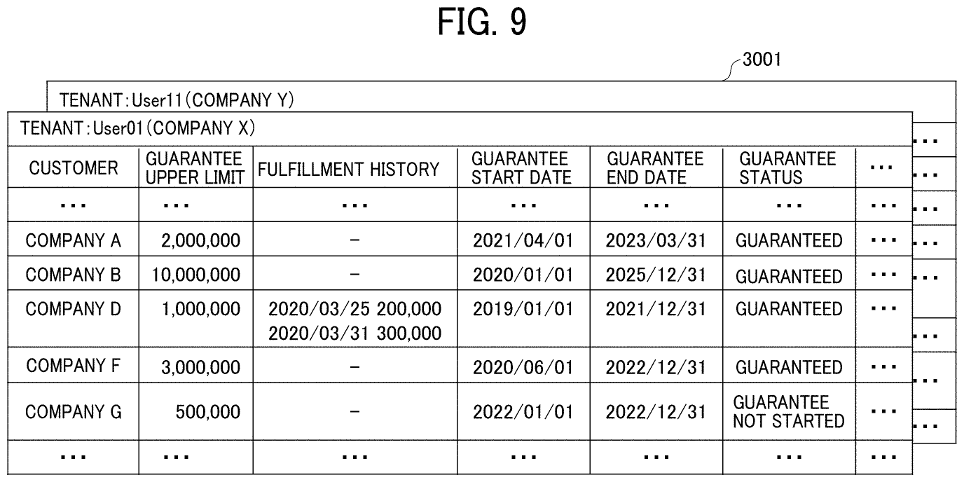

FIG. 9 is a conceptual diagram illustrating an example debt guarantee information table that stores debt guarantee information. The debt guarantee information storage 300 stores a debt guarantee information management DB 3001, implemented by the debt guarantee information table as illustrated in FIG. 9. The debt guarantee information table stores information representing a status of a contract and a fulfillment history of the debt guarantee for the customer company B, for which the service user company A requests application for the debt guarantee service.

As illustrated in FIG. 9, the debt guarantee information table stores, for each tenant, a name of a customer (for example, company name), a guarantee upper limit, a history of fulfillment of debt guarantee, a guarantee start date, a guarantee end date, a guarantee status, etc., in association with one another.

Fulfillment Information Table

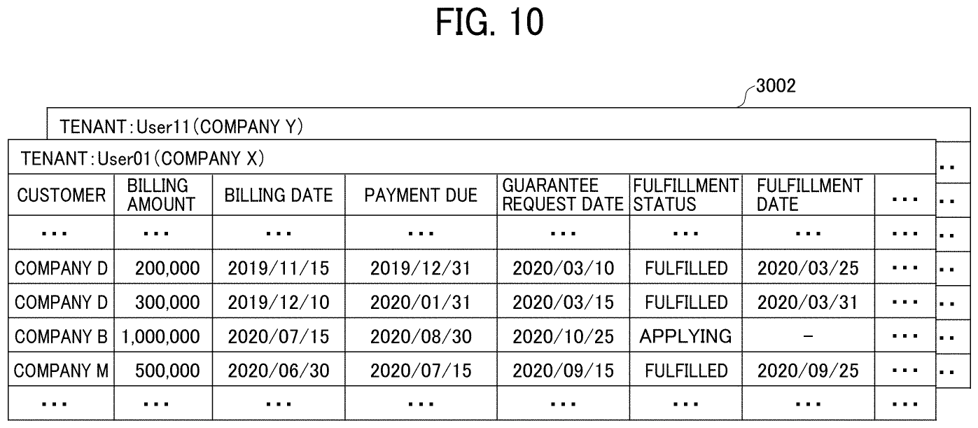

FIG. 10 is a conceptual diagram illustrating an example fulfillment information table that stores fulfillment information. The debt guarantee information storage 300 stores a fulfillment information management DB 3002, implemented by the fulfillment information table as illustrated in FIG. 10. The fulfillment information table stores a history (fulfillment history) of applications for debt guarantee service by the service user company A.

As illustrated in FIG. 10, the fulfillment information table stores, for each tenant, a name of a customer (for example, company name), a billing amount, a billing date, a payment due date, a fulfillment request date, a fulfillment status, a fulfillment date, etc., in association with one another.

Functional Configuration of Debt Management Server

As illustrated in FIG. 4, the debt management server 40 according to the embodiments includes a debt management information storage 400, a screen data storage 410, a storage control unit 41, a communication unit 42, a data obtainer 43, a screen generator 44, a determination unit 45, and an execution unit 46.

The debt management information storage 400 stores debt management information, credibility information, and transaction history information used in the debt management service.

The screen data storage 410 stores screen data for displaying a screen to be provided (transmitted) to the user terminal 50. The screen data is, for example, screen data described in HyperText Markup Language (HTML), and may include an application described in JAVASCRIPT or any other language.

The debt management information storage 400 and the screen data storage 410 are implemented by, for example, the HD 504 illustrated in FIG. 2.

The storage control unit 41 writes and reads data to and from the debt management information storage 400 and the screen data storage 410. The storage control unit 41 is implemented by, for example, processing performed by the CPU 501 and the HDD controller 505 according to a program loaded from the HD 504 onto the RAM 503, of which elements are illustrated in FIG. 2.

The communication unit 42 transmits and receives various types of information to and from other servers, devices, or systems via the communication network N1. The communication unit 42 is implemented by, for example, processing executed by the CPU 501 and the network I/F 509 according to a program loaded from the HD 504 onto the RAM 503, as illustrated in FIG. 2.

The data obtainer 43 instructs the communication unit 42 to acquire information from each server of the transaction management system 2, and instructs the storage control unit 41 to store debt management information in the debt management information storage 400.

The screen generator 44 instructs the storage control unit 41 to read the screen data from the screen data storage 410, and instructs the communication unit 42 to transmit the screen data to the user terminal 50.

The determination unit 45 instructs the storage control unit 41 to read the debt management information from the debt management information storage 400, and performs a predetermined determination based on the debt management information.

The execution unit 46 receives a request for collection from the user terminal 50 via the communication unit 42, and executes collection according to the request from the user terminal 50.

The data obtainer 43, the screen generator 44, the determination unit 45, and the execution unit 46 are implemented by, for example, processing executed by the CPU 501 according to a program loaded from the HD 504 onto the RAM 503, as illustrated in FIG. 2.

Debt Management Information Table

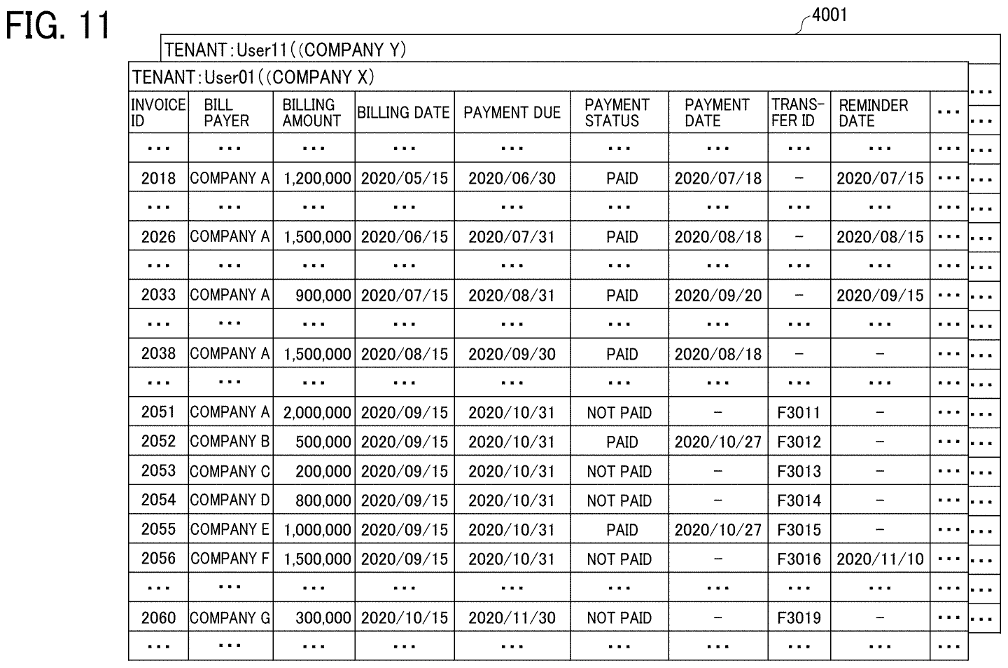

FIG. 11 is a conceptual diagram illustrating an example of a debt management information table that stores debt management information.

The debt management information storage 400 stores a debt management information management DB 4001, implemented by the debt management information table as illustrated in FIG. 11. The debt management information table stores information on debt based on invoices issued by the service user company A.

As illustrated in FIG. 11, the debt management information table stores, for each tenant, an invoice ID, a name of a bill payer (for example, company name), a billing amount, a billing date, a payment due date, a payment status, a payment date, a transfer ID, a reminder date (a history of sending a reminder), etc., in association with one another. The payment status, which indicates whether payment has been made for the billing amount, may also be referred to as a collection status, as the payment is an example of debt.

Credit Information Table

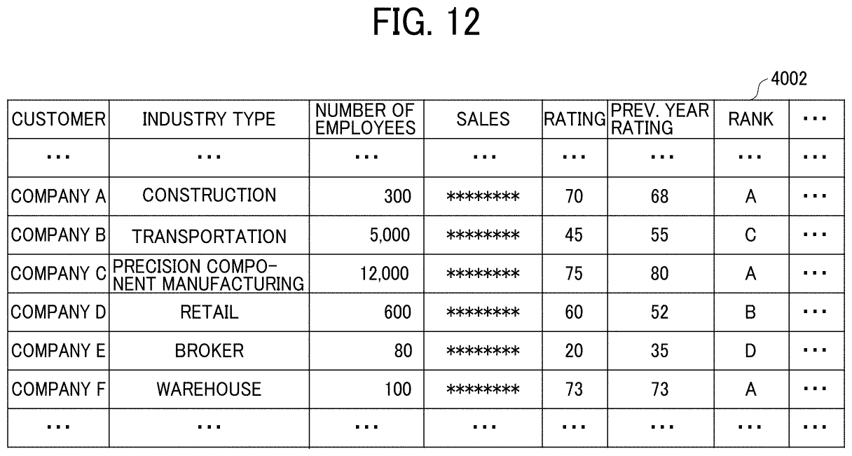

FIG. 12 is a conceptual diagram illustrating an example credibility information table that stores credibility information. The debt management information storage 400 stores a debt information management DB 4002, implemented by the credibility information table as illustrated in FIG. 12. The credibility information table stores credibility information on the customer company B.

As illustrated in FIG. 12, the credibility information table stores, a name of a customer (for example, a company name), an industry type, the number of employees, a sales amount, a rating, a rating in the previous year, a rank, etc., in association with one another. The credibility information stored in the credibility information table is obtained by extracting information on the customer of the service user company A from the credibility information acquired in advance from the credibility information service company G. As the credibility information, a degree of credibility calculated by the transaction management system 2 based on information collected by the transaction management system 2 may be used.

Transaction History Information Table

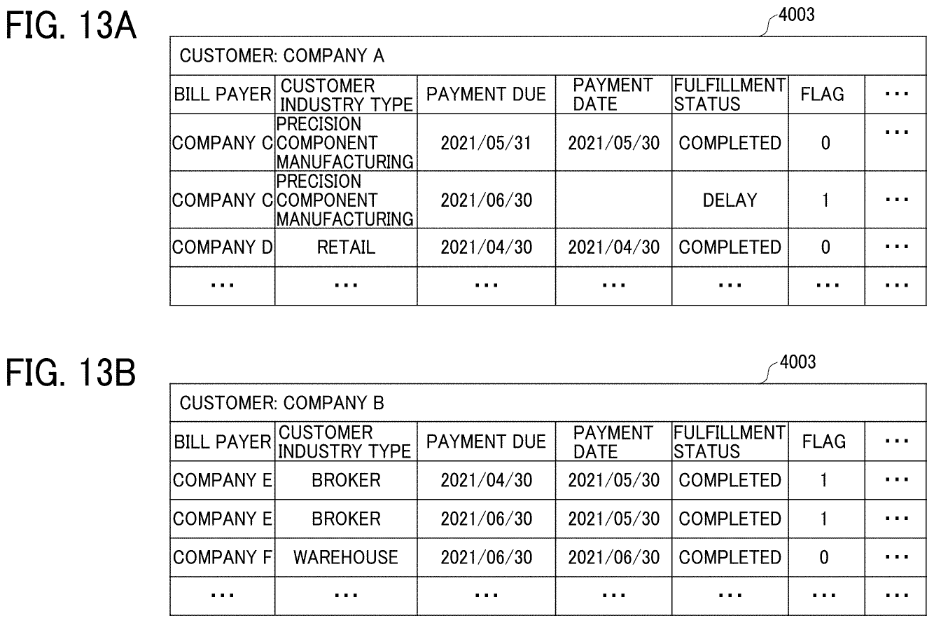

FIGS. 13A and 13B (FIG. 13) are a conceptual diagram illustrating an example transaction history information table that stores transaction history information.

The debt management information storage 400 stores a transaction history information management DB 4003, implemented by the transaction history information table as illustrated in FIG. 13. The transaction history information table stores information on an issuance status and a collection status of debt based on each invoice issued by the service user company A to a customer company, such as the customer company B.

As illustrated in FIG. 13, the transaction history information table stores, for each customer, a bill payer name (for example, company name), industry type of a customer, a payment due date, a payment date, a fulfillment status of debt (completed or delay in fulfillment), a flag indicating the payment tendency, etc., in association with one another. The “completed” in the fulfillment status means a status in which collection of debt has been completed. The “delay” in the fulfillment status means that collection of debt is delayed. Since the transaction history information stores information on the invoices having been issued, information indicating whether a specific entry exists in the transaction history information represents an issuance status indicating whether or not the invoice is issued.

Functional Configuration of User Terminal

As illustrated in FIG. 4, the user terminal 50 according to the embodiments includes a display controller 51, a communication unit 52, and an operation input 53.

The display controller 51 displays a screen based on screen data received by the communication unit 52. The display controller 51 is, for example, a web browser installed at the user terminal 50. The display controller 51 is implemented by, for example, processing performed by the CPU 501 and the display 506 according to a program loaded from the HD 504 onto the RAM 503, of which elements are illustrated in FIG. 2.

The communication unit 52 transmits and receives various types of information to and from the servers, devices, or systems via the communication network N1. The communication unit 52 is implemented by, for example, processing executed by the CPU 501 and the network I/F 509 according to a program loaded from the HD 504 onto the RAM 503, as illustrated in FIG. 2.

The operation input 53 receives various operations performed by the user. The operation input 53 is implemented by, for example, instructions from the CPU 501, and the keyboard 511 or the pointing device 512, illustrated in FIG. 2.

Processing Performed by Information Processing System

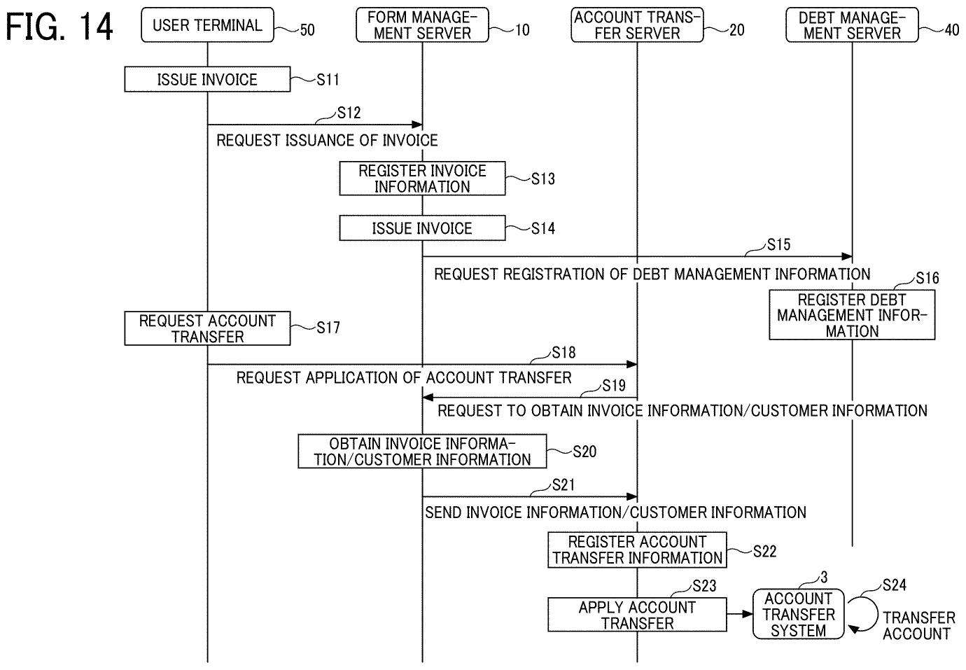

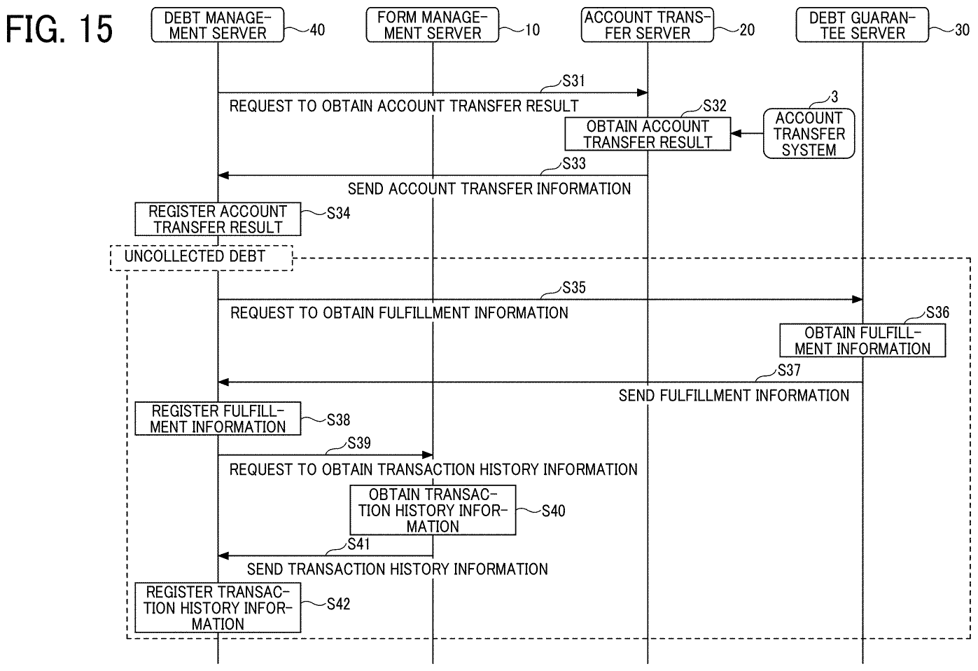

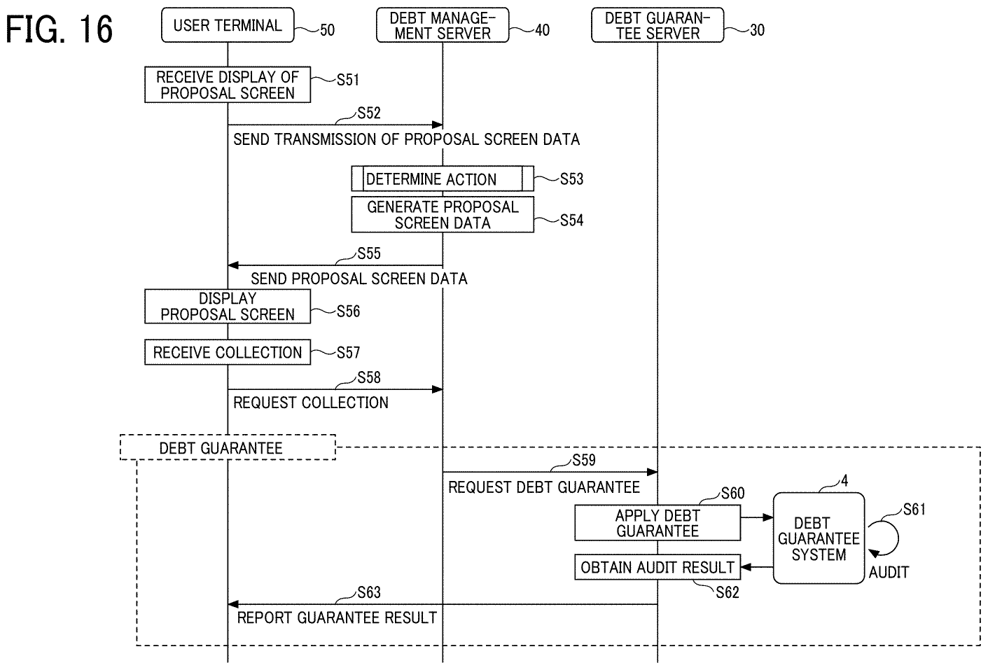

Referring to FIGS. 14 to 20, processing in an information processing method, executed by the information processing system, is described according to the embodiment. FIGS. 14 to 16 are a sequence diagram illustrating an example processing in the information processing method according to the embodiment. The information processing method according to the embodiment includes account transfer processing (see FIG. 14), information collection processing (see FIG. 15), and proposal processing (see FIG. 16).

Account Transfer Processing

FIG. 14 is a sequence diagram illustrating example account transfer processing according to the embodiment.

At S11, the operation input 53 of the user terminal 50 receives a user operation of instructing issuance of an invoice. In prior to receiving the user operation of instructing issuance of the invoice, the operation input 53 is assumed to receive authentication information such as a tenant ID, which is identification information of a tenant, input by the user. The communication unit 52 transmits the authentication information to the form management server 10, such that predetermined authentication processing is performed at the form management server 10. Only when the user is authenticated by the form management server 10, the operation input 53 receives the operation of instructing the issuance of the invoice by the user.

At S12, the communication unit 52 of the user terminal 50 transmits an invoice issuance request to the form management server 10 in response to the operation of instructing issuance of the invoice. The issuance request includes invoice information input by the user. The invoice information includes, for example, information to be written on the invoice, such as a name of a bill payer, a billing amount, a billing date, and a payment due date.

The communication unit 12 of the form management server 10 receives the invoice issuance request transmitted from the user terminal 50. At S13, the storage control unit 11 stores the received invoice information in the invoice information management DB 1002. At this time, the storage control unit 11 issues an invoice ID for identifying the invoice information, and stores the invoice information in association with the invoice ID, as illustrated in FIG. 6.

At this time, the storage control unit 11 determines whether the bill payer included in the received invoice information has been registered in the customer information management DB 1001. When the bill payer included in the invoice information is not registered in the customer information management DB 1001, the storage control unit 11 stores the information on the customer (that is, bill payer) in the customer information management DB 1001. At this time, the storage control unit 11 issues a bill payer ID for identifying the customer or the customer information on the customer. The bill payer ID is then stored in the invoice information management DB 1002, as a part of the invoice information.

At S14, the communication unit 12 of the form management server 10 creates an invoice based on the registered invoice information, and sends the invoice to the customer company B. There are various ways to send the invoice, including, for example, mailing the invoice printed, sending an e-mail to which the invoice is attached, or sending a notification with a URL (Uniform Resource Locator) link to the invoice.

At S15, the communication unit 12 of the form management server 10 transmits a request for registering the debt management information to the debt management server 40. The registration request includes the invoice information stored in the invoice information management DB 1002.

The communication unit 42 of the debt management server 40 receives the registration request of the debt management information transmitted by the form management server 10. At S16, the storage control unit 41 stores the debt management information in the debt management information management DB 4001 based on the received invoice information. Referring to FIG. 11, as the debt management information, the storage control unit 41 stores the invoice ID, bill payer, billing amount, billing date, and payment due date.

At S17, the operation input 53 of the user terminal 50 receives an operation of instructing an application for account transfer by the user. Such operation includes specifying a particular invoice for which account transfer is to be applied. At this time, the user may specify a plurality of invoices.

At S18, the communication unit 52 of the user terminal 50 transmits a request for applying account transfer to the account transfer server 20 in response to an operation of instructing application of account transfer. The application request includes an invoice ID for identifying the invoice specified by the user.

The communication unit 22 of the account transfer server 20 receives the request for application of account transfer, transmitted by the user terminal 50. At S19, the storage control unit 21 requests the form management server 10 to acquire the invoice information and the customer information identified by the received invoice ID. The request to acquire the invoice information includes the invoice ID of the specified invoice.

The communication unit 12 of the form management server 10 receives the request for acquiring the invoice information and the customer information transmitted by the account transfer server 20. At S20, the storage control unit 11 reads the invoice information identified with the received invoice ID from the invoice information management DB 1002. Further, the storage control unit 11 reads the customer information identified with the bill payer ID included in the read invoice information from the customer information management DB 1001.

At S21, the communication unit 12 of the form management server 10 transmits the invoice information and the customer information read by the storage control unit 11 to the account transfer server 20.

The communication unit 22 of the account transfer server 20 receives the invoice information and the customer information transmitted by the form management server 10. At S22, the storage control unit 21 stores the account transfer information in the account transfer information management DB 2002 based on the received invoice information and customer information. At this time, the storage control unit 21 issues a transfer ID for identifying the account transfer information regarding the account transfer, requested by the user. For example, referring to FIG. 8, the storage control unit 21 stores the invoice ID, bill payer, billing amount in the invoice information of the specified invoice, in association with the transfer ID.

At S23, the communication unit 22 of the account transfer server 20 transmits an application for account transfer to the account transfer system 3 based on the registered account transfer information. The application includes the transfer ID, the account information of the tenant, the account information of the customer, the billing amount, the transfer date, etc.

The account information of the tenant is preset for each tenant. The account information of the customer is included in the customer information. The billing amount is included in the invoice information. As the transfer date, a transfer date on which account transfer is performed most recently is automatically set.

At S24, the account transfer system 3 registers the account transfer application received from the account transfer server 20. The account transfer system 3 requests the financial institution E to process transfer of the billing amount from one account (in this example, the customer account) to another account (in this example, the user company account), as indicated by the registered account transfer application, on a predetermined transfer date. The financial institution E processes the account transfer in response to a request for processing account transfer.

Information Collection Processing

FIG. 15 is a sequence diagram illustrating an example information collection processing according to the embodiment.

At S31, the data obtainer 43 of the debt management server 40 instructs the communication unit 42 to send a request to the account transfer server 20 to acquire a result of account transfer (account transfer result). The communication unit 42 transmits a request for obtaining the account transfer result to the account transfer server 20. The request for obtaining includes an invoice ID of the invoice for which the account transfer result is to be obtained. The invoice for which the account transfer result is to be obtained is, for example, an invoice for which account transfer was performed on the recent transfer date. In this disclosure, it is assumed that account transfer is to be performed once every month, so that there is one preset transfer date for each month. The number of invoices is not limited to one.

The communication unit 22 of the account transfer server 20 receives the request for obtaining the account transfer result, transmitted by the debt management server 40. At S32, the storage control unit 21 reads account transfer information identified with the received invoice ID, from the account transfer information management DB 2002. Subsequently, the communication unit 22 transmits a request for obtaining the account transfer result to the account transfer system 3. The request for obtaining includes a transfer ID included in the account transfer information read using the invoice ID at S32.

The account transfer system 3 returns the account transfer result identified with the transfer ID to the account transfer server 20. The communication unit 22 receives the account transfer result. Then, the storage control unit 21 registers the received account transfer result, in the “transfer field” of the account transfer information management DB 2002, in association with the identified transfer ID (see FIG. 8).

The storage control unit 21 updates the account transfer application management DB 2001 based on the received account transfer result. Specifically, the storage control unit 21 sums up the billing amounts of the account transfers having been completed for each customer, and registers the total billing amount in the “total collection amount” field in the account transfer application table (see FIG. 7). When all account transfers indicated by the application are completed, the collection result is updated to “collected”. On the other hand, when there is an uncompleted account transfer in the application, the collection result is updated to “partly not collectable”.

At S33, the communication unit 22 of the account transfer server 20 transmits the account transfer information for which the account transfer result is registered to the debt management server 40.

The communication unit 42 of the debt management server 40 receives the account transfer information transmitted by the account transfer server 20. At S34, the storage control unit 41 stores the account transfer information that is received in the debt management information storage 400. The storage control unit 41 further registers the transfer ID included in the received account transfer information in the debt management information management DB 4001. For example, the storage control unit 41 stores (or updates) the payment status, payment date, and transfer ID, obtained from the account transfer information.

Subsequent steps S35 to S42 are executed in a case where account transfer is not completed (i.e., there is an uncollected debt).

In this disclosure, the uncollected debt means that the total billing amount described on the invoice has not been deposited. Specifically, the debt indicated by the invoice for which a transfer result of the account transfer information is not “transferred” is considered as an uncollected debt.

At S35, the data obtainer 43 of the debt management server 40 instructs the communication unit 42 to send a request to the debt guarantee server 30 to acquire fulfillment information of a customer (that is, bill payer) identified with uncollected debt. The communication unit 42 transmits a request for obtaining the fulfillment information to the debt guarantee server 30. The request for obtaining includes information indicating a billing destination (bill payer) included in the account transfer information for which transfer has not been completed.

The communication unit 32 of the debt guarantee server 30 receives the request for obtaining the fulfillment information transmitted by the debt management server 40. At S36, the storage control unit 31 reads out the fulfillment information for the bill payer that is received with the request, from the fulfillment information management DB 3002.

At S37, the communication unit 32 of the debt guarantee server 30 transmits the fulfillment information of the bill payer that is read to the debt management server 40.

The communication unit 42 of the debt management server 40 receives the fulfillment information transmitted by the debt guarantee server 30. At S38, the storage control unit 41 stores the received fulfillment information in the debt management information storage 400.

At S39, the data obtainer 43 of the debt management server 40 instructs the communication unit 42 to transmit a request to the form management server 10 to acquire transaction history information. Specifically, the communication unit 42 transmits a request for obtaining transaction history information to the form management server 10. The request for obtaining includes the invoice ID included in the account transfer information for which transfer has not been completed, which is the same as the one included in the request for obtaining fulfillment information at S35.

The communication unit 12 of the form management server 10 receives the request for obtaining the transaction history information transmitted by the debt management server 40. At S40, the storage control unit 11 reads the invoice information identified with the received invoice ID from the invoice information management DB 1002.

Subsequently, the storage control unit 11 specifies a bill payer included in the invoice information, which is identified with the received invoice ID and read from the invoice information management DB 1002, and reads out invoice information of the specified bill payer. Specifically, the storage control unit 11 obtains invoice information of the specified bill payer, stored in the invoice information table for the other tenant other than the user. The storage control unit 11 generates transaction history information of the bill payer based on the invoice information that is read.

At S41, the communication unit 12 of the form management server 10 transmits the generated transaction history information to the debt management server 40.

The communication unit 42 of the debt management server 40 receives the transaction history information transmitted by the form management server 10. At S42, the storage control unit 41 stores the received transaction history information in the transaction history information management DB 4003 (see FIGS. 13A and 13B). For example, the storage control unit 41 stores the bill payer, and the payment due date, obtained from the invoice information, in the transaction history information.

The industry type of a customer included in the transaction history information is read from the debt information management DB 4002.

The fulfillment status included in the transaction history information is set to “completed” if the payment date is entered, and is set to “delay” if the payment due date has passed and the payment date is not entered. The flag included in the transaction history information is set to “1” if the payment due date and the payment date are the same month, and is set to “0” otherwise. The flag may be set by the storage control unit 11 based on the transaction history information.

FIG. 13A illustrates an example of transaction history information for the company A, which is a customer. FIG. 13B illustrates an example of transaction history information for the company B, which is another customer. For example, referring to the transaction history information for the company A, the company C has not paid the billing amount to the company A, as indicated by a certain invoice whose due date is Jun. 30, 2021. Therefore, in the transaction history information related to this transaction, the fulfillment status is set to “delay” and the flag is set to “1”. In another example, referring to the transaction history information for the company B, the company E has paid the billing amount to the company B on a month different from that of the payment due date. The flag in the transaction history information for the customer E is set to “1”.

Here, an example has been described in which step S35 to step S42 are executed only for a billing destination (bill payer) of the account transfer for which transfer is not completed. Alternatively, step S35 to step S42 may be executed for all the customers after step S22 of FIG. 14. With this configuration, a warning may be given in advance when there is a customer with a high risk from among customers for which account transfer has been requested.

Proposal Processing

FIG. 16 is a sequence diagram illustrating an example of proposal processing according to the embodiment.

At S51, the operation input 53 of the user terminal 50 receives an operation of instructing display of a proposal screen by the user. The operation of instructing display of the proposal screen is, for example, an operation of pressing a button included in a debt list screen that displays a list of debt management information.

Debt List Screen

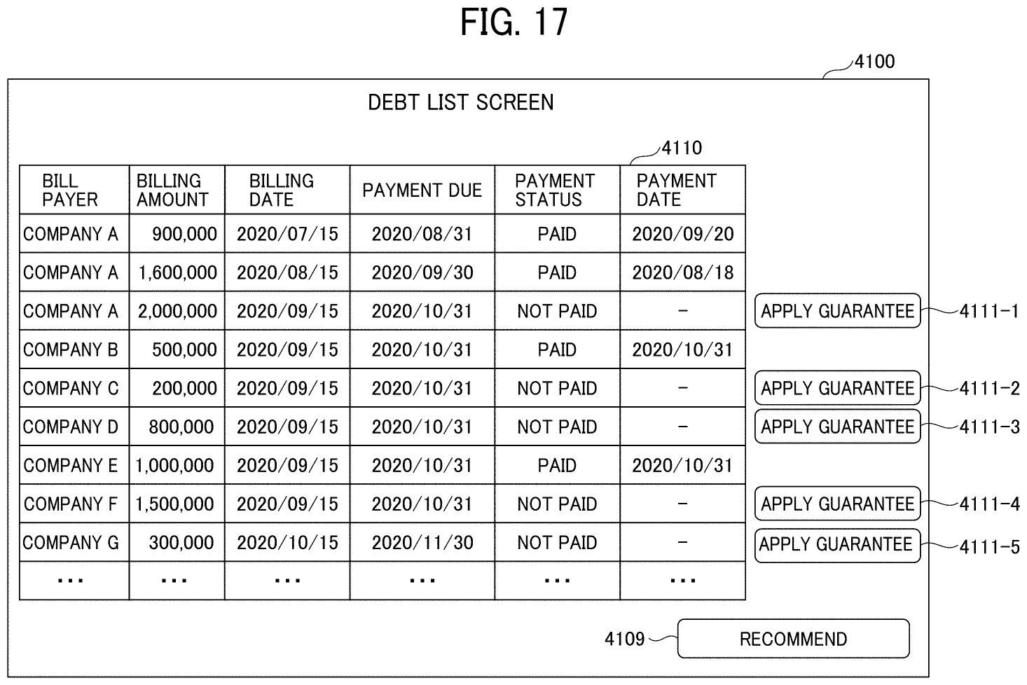

Referring to FIG. 17, a debt list screen is described according to the embodiment. FIG. 17 is an illustration of an example of a debt list screen according to the embodiment.

The debt list screen of FIG. 17 is displayed according to a request from the user terminal 50. For example, the request includes information identifying the user, such as a tenant ID. Using the tenant ID, the debt management server 40 generates the debt list screen based on the debt management information of the user, which is stored in the debt management information storage 400.

As illustrated in FIG. 17, the debt list screen 4100 according to the embodiment includes a debt list display field 4110 for displaying a list of items of debt management information managed by the debt management server 40, and a recommend button 4109 for instructing to display a proposal screen.

Among the respective items of debt management information displayed in the debt list display field 4110, for each item of the debt management information in which the payment due date has passed and the payment status is “not paid”, an application button 4111 is displayed. The application button 4111 can be selected by the user when applying for debt guarantee service to cover an amount indicated by the debt management information.

At S51, when the user presses the recommend button 4109 on the debt list screen 4100, the operation input 53 receives an operation of instructing display of a proposal screen.

In the debt list screen 4100, when the user presses the application button 4111, the operation input 53 receives an operation of requesting debt guarantee. When the operation input 53 receives the operation of requesting for the debt guarantee service via a particular application button 4111, a process of applying for the debt guarantee service is performed on the debt management information corresponding to the particular application button 4111. The processing of applying for the debt guarantee service will be described below.

Returning to FIG. 16, description continues. At S52, the communication unit 52 of the user terminal 50 requests the debt management server 40 to send screen data for displaying a proposal screen in response to the operation of instructing display of the proposal screen.

The communication unit 42 of the debt management server 40 receives a request for transmitting screen data, from the user terminal 50. Next, the storage control unit 41 reads the debt management information for the uncollected debt, from the debt management information management DB 4001. At S53, the determination unit 45 determines an action to collect the debt for each of the debt management information items that are read.

Action Determination Processing

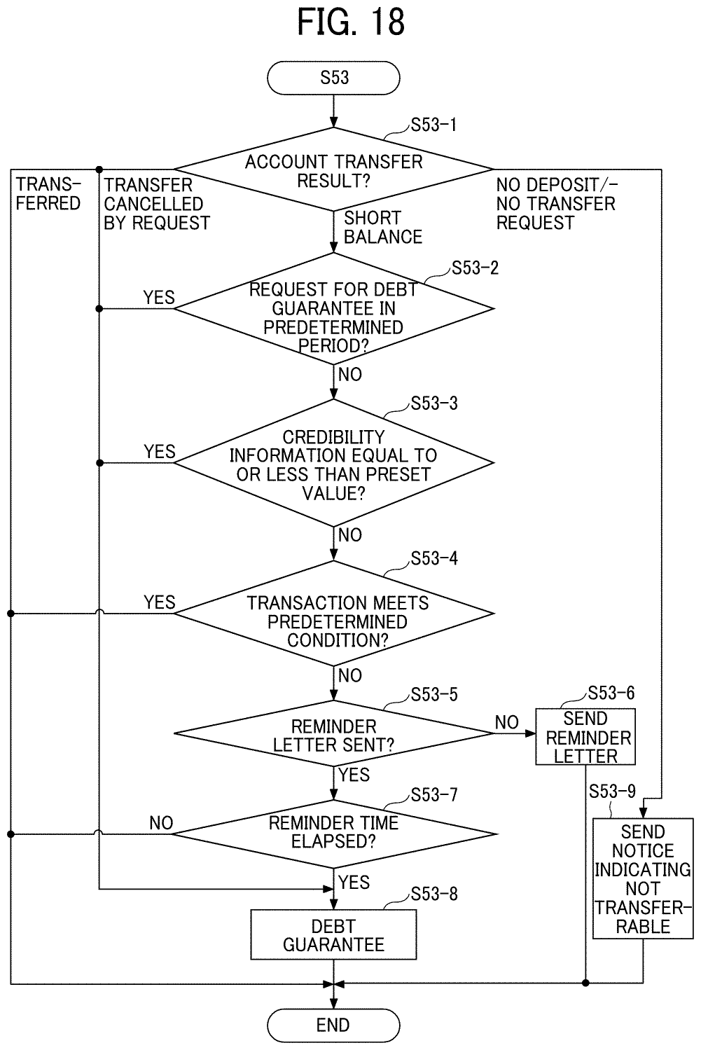

Referring to FIG. 18, processing of S53 executed by the determination unit 45 is described in more detail according to the embodiment. FIG. 18 is a flowchart illustrating an example of action determination processing of S53.

The action determination processing illustrated in FIG. 18 is executed for each of the debt management information items having payment status of “not paid”. Through this processing, one of actions to be performed to collect debt is selected and determined for each of the debt management information items indicating the uncollected debt.

At S53-1, the determination unit 45 selects particular debt management information for processing, and further selects an account transfer result for the selected debt management information. Specifically, the determination unit 45 specifies account transfer information by a particular transfer ID included in the debt management information that is selected, and acquires the transfer result of the specified account transfer information.

When the transfer result is “transferred”, the determination unit 45 ends the processing. When the transfer result is “short balance”, the determination unit 45 proceeds the processing to S53-2. When the transfer result is “transfer cancelled by request”, the determination unit 45 proceeds the processing to S53-8. Further, when the transfer result is “no deposit” or “no transfer request”, the determination unit 45 proceeds the processing to step S53-9.

At S53-2, the determination unit 45 determines whether or not a request for debt guarantee service has been made, in relation to the particular customer within a predetermined period. Specifically, the determination unit 45 acquires the fulfillment information for a particular bill payer (billing destination) included in the debt management information that is selected. Then, the determination unit 45 calculates the number of days from the latest guarantee request date to the current date in the acquired fulfillment information, and determines whether or not the calculated number of days is greater than the number of days in the predetermined period. In this disclosure, the predetermined period may be set to any desired time period. The predetermined period may be preferably set to, for example, any time period equal to one year or less.

When no request is made for the debt guarantee service within the predetermined period (NO), the determination unit 45 proceeds the processing to S53-3. On the other hand, when a request has been made for the debt guarantee service within the predetermined period (YES), the determination unit 45 proceeds the process to S53-8.

At S53-3, the determination unit 45 determines whether or not the credibility information of the particular customer is equal to or less than a preset reference value. Specifically, the determination unit 45 reads the credibility information for a particular bill payer included in the debt management information that is selected, from the debt information management DB 4002, and determines whether or not the credibility information satisfies a preset condition.

The preset reference value, or condition, may be set according to the preference. For example, the preset reference value may be determined such that the rating of the credibility information is equal to or higher than C, or the rating has not been lowered by 10 points or more from the rating of the previous year.

When the credibility information is not equal to or less than the preset reference value (NO), the determination unit 45 proceeds the processing to S53-4. When the credibility information is equal to or less than the preset reference value (YES), the determination unit 45 proceeds the processing to S53-8.

At S53-4, the determination unit 45 determines whether or not transactions between the particular customer and the other companies satisfies a predetermined condition. Specifically, the determination unit 45 reads the transaction history information for the particular bill payer included in the debt management information that is selected, from the transaction history information management DB 4003, and determines whether or not the transaction history information satisfies the predetermined condition.

The predetermined condition may be set according to the preference, for example, based on the commercial practice or empirical rule. For example, it is assumed that the transaction history information indicating the transactions carried out between the customer and the other tenant(s) for a predetermined period (for example, six months) in the past is analyzed. The transaction records indicate that the payment date was later than the payment due date in all transactions, but the payment was made within a predetermined period (for example, within one month) from the payment due date. In such a case, the customer always passes the payment due date, but the user is likely to receive the payment soon after waiting, such that it may be safe to just wait to see.

In view of the above, the transaction history information indicating the transactions carried out between the customer and the other tenant(s) for a predetermined period in the past is analyzed. The predetermined condition may be set, so as do determine to exclude the case where the transaction records indicate that the payment date was later than the payment due date in all transactions, but the payment was made within a predetermined period from the payment due date. In such case, it can be determined that it is safe to wait, as the user is likely to receive the payment soon after waiting.

In another example, it may be desired to exclude a delay of a specific customer from the subject for analysis, when a notification indicating that payment is delayed is received from such customer in advance. In such case, the specific customer to be excluded from the subject may be registered in advance. The predetermined condition is set to exclude the specific customer having been registered.

When the transactions with the other companies does not satisfy the predetermined condition (NO), the determination unit 45 proceeds the processing to S53-5. When the transactions with the other companies satisfies the predetermined condition (YES), the determination unit 45 ends the processing.

At S53-5, the determination unit 45 determines whether or not a reminder letter has been sent to the particular customer. Specifically, the determination unit 45 acquires the reminder date included in the debt management information that is selected. When the reminder date has been entered, it is determined that the reminder letter has been sent.

When the reminder date has not been entered, it is determined that the reminder letter has not been sent.

In a case where the reminder letter has not been transmitted (NO), the determination unit 45 proceeds the processing to S53-6. In a case where the reminder letter has been transmitted (YES), the determination unit 45 proceeds the processing to S53-7.

At S53-6, the determination unit 45 determines that the collection action proposed for the debt management information that is selected is “send a reminder letter”, and ends the processing. The reminder letter may be sent by any method such as mailing the reminder letter that is printed, or sending an e-mail with a reminder attached thereto. Alternatively, the form management server 10 may be caused to transmit the reminder letter in response to a request from the debt management server 40.

At S53-7, the determination unit 45 determines whether or not a reminder time limit has expired. Specifically, the determination unit 45 acquires the reminder date included in the debt management information that is selected, and determines whether or not a predetermined period (for example, one month) has elapsed from the acquired reminder date. Alternatively, for example, the user may set a reminder time limit when sending a reminder letter, and register the reminder time limit in the debt management information.

In a case where the reminder time limit is exceeded (YES), the determination unit 45 proceeds the processing to S53-8. In a case where the reminder time limit is not exceeded (NO), the determination unit 45 ends the processing.

At S53-8, the determination unit 45 determines that the collection action proposed for the debt management information is “debt guarantee”, and ends the processing. “Debt guarantee” means that the debt guarantee system 4 is requested to provide the debt guarantee service to cover the debt.

At S53-9, the determination unit 45 determines that the collection action to be proposed for the debt management information is “send notice indicating not transferrable”, and ends the processing. The “send notice indicating not transferrable” means notifying the user terminal 50 that the account transfer cannot be carried out with the registered account information.

When the transfer result is “no deposit” or “no transfer request”, there is a high possibility that there is a defect in the previous procedure, such as in the case where the registered account information is incorrect. In such case, if the user confirms information being registered and correctly performs the procedure again, the account transfer may be successfully performed. Therefore, if the user is notified of an error and the account transfer is performed again, it is expected that the debt can be collected.

Returning to FIG. 16, description continues. At S54, the storage control unit 41 of the debt management server 40 reads out screen data for displaying the proposal screen from the screen data storage 410. The screen generator 44 then generates screen data to be displayed on the user terminal 50 based on the screen data read by the storage control unit 41. At this time, the screen generator 44 embeds the debt management information for the uncollected debt, in the screen data for displaying the proposal screen, in association with the collection action determined by the determination unit 45.

At S55, the communication unit 42 of the debt management server 40 transmits the screen data generated at S54 to the user terminal 50.

The communication unit 52 of the user terminal 50 receives the screen data for displaying the proposal screen from the debt management server 40. At S56, the display controller 51 displays the proposal screen on the display 506 based on the received screen data.

Proposal Screen

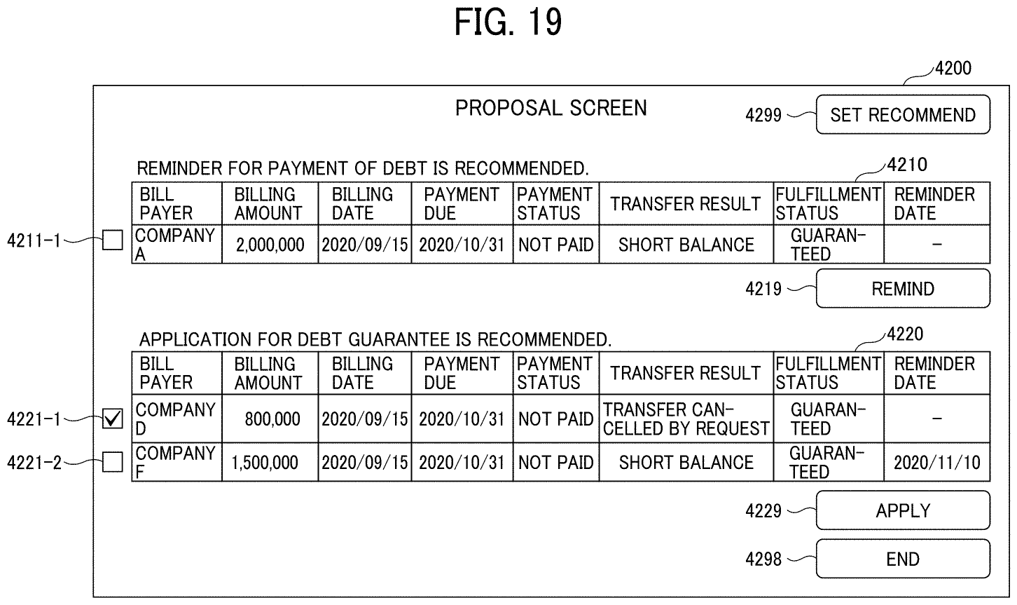

Referring to FIG. 19, the proposal screen is described according to the embodiment. FIG. 19 is a diagram illustrating an example of a proposal screen according to the embodiment.

As illustrated in FIG. 19, the proposal screen 4200 according to the embodiment includes a reminder proposal display field 4210 for displaying information on an invoice that transmission of a reminder has been proposed, a debt guarantee proposal display field 4220 for displaying information on an invoice that request for debt guarantee service has been proposed, a reminder execution button 4219 for sending a reminder, an apply button 4229 for requesting the debt guarantee, an end button 4298, and a setting button 4299 for displaying a setting screen.

The reminder proposal display field 4210 displays therein information based on the debt management information for which the collection action of “send a reminder letter” was determined by the determination unit 45. The reminder proposal display field 4210 further displays a check box 4211 (could be radio button, or any other graphical image) to be checked to select a particular debt management information, for each debt management information being displayed.

The debt guarantee proposal display field 4220 displays therein information based on the debt management information for which the collection action of “debt guarantee” was determined by the determination unit 45. The debt guarantee proposal display field 4220 further displays a check box 4221 (could be radio button, or any other graphical image) to be checked to select a particular debt management information, for each debt management information being displayed.

When the user presses the reminder execution button 4219 on the proposal screen 4200, the operation input 53 receives an instruction to send a reminder letter. When the operation input 53 receives the instruction to send the reminder letter, a process of sending the reminder letter is executed for the debt management information for which the check box 4211 is selected.

In the proposal screen 4200, when the user presses the apply button 4229, the operation input 53 receives an instruction to request debt guarantee. When the operation input 53 receives the instruction to request the debt guarantee service, a process of applying for the debt guarantee service is performed on the debt management information corresponding to the check box 4221 that is selected.

When the user presses the end button 4298 on the proposal screen 4200, the display controller 51 closes the proposal screen 4200. In this case, the collection action displayed on the proposal screen 4200 is not executed. As described above, by providing the end button 4298 on the proposal screen 4200, it is possible to receive, as a users selection, a decision to continue to observe without performing a specific action on an uncollected debt.

When the user presses the setting button 4299 on the proposal screen 4200, the operation input 53 receives an instruction to display a setting screen. In response to the instruction to display the setting screen, the display controller 51 displays, on the display 506, a setting screen for setting information to be used by the determination unit 45 in the action determination process.

When the debt guarantee service is applied to the debt displayed in the debt guarantee proposal display field 4220, if there is a customer who exceeds the guarantee upper limit, the proposal screen 4200 may display information indicating such fact.

Specifically, at S54, the storage control unit 41 reads, from the debt guarantee information management DB 3001, the debt guarantee information related to the bill payer of the debt for which the collection action is determined to be “debt guarantee”. The screen generator 44 determines whether or not an amount, which is obtained by adding the total billing amount of the selected debt management information to the total amount in the fulfillment history, exceeds the guarantee upper limit of the debt guarantee information. When it is determined that the calculated amount exceeds the guarantee upper limit, the screen generator 44 includes information indicating that the guarantee upper limit is reached in the screen data for displaying the proposal screen 4200.

Setting Screen

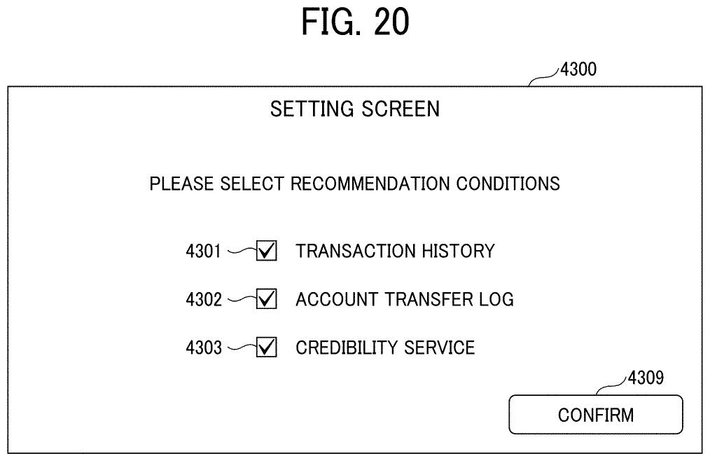

Referring to FIG. 20, the setting screen will be described according to the embodiment. FIG. 20 is an illustration of an example of a setting screen according to the embodiment.

As illustrated in FIG. 20, the setting screen 4300 according to the embodiment includes check boxes 4301 to 4303 for setting whether or not one or more of the transaction history, the account transfer result, and the credibility information are used in the action determination processing, and a confirmation button 4309. When the user changes the checked statuses of the check boxes 4301 to 4303 and presses the confirmation button 4309, information used for the action determination processing is set in the determination unit 45.

When it is set that the transaction history is not used in the action determination processing, the determination unit 45 skips S53-4 of the action determination processing. When it is set that the account transfer result is not used in the action determination processing, the determination unit 45 skips S53-1 of the action determination processing.

When it is set that the credibility information is not used in the action determination processing, the determination unit 45 skips S53-3 of the action determination processing.

Returning to FIG. 16, description continues. At S57, the operation input 53 of the user terminal 50 receives an operation of instructing execution of the collection action by the user. The operation of instructing execution includes specifying an invoice subjected to the collection action. At this time, the user may specify a plurality of invoices. In the following description, it is assumed that the user has performed an operation of instructing to apply for the debt guarantee service.

At S58, the communication unit 52 of the user terminal 50 transmits a request for executing collection action to the debt management server 40 in response to the operation of instructing the execution of the collection action. The execution request includes information indicating a particular collection action instructed by the user and an invoice ID for identifying the invoice specified by the user.

At S59, the communication unit 42 of the debt management server 40 receives the request for executing the collection action transmitted by the user terminal 50. The execution unit 46 executes the collection action based on the received information indicating the collection action. In this example, the execution unit 46 instructs the communication unit 42 to request the debt guarantee server 30 to perform processing to provide the debt guarantee service. The communication unit 42 transmits a request for debt guarantee service to the debt guarantee server 30. The debt guarantee request includes an invoice ID for identifying the specified invoice and information representing a bill payer.

When the user instructs to send a reminder letter, the execution unit 46 creates a reminder letter and sends the reminder letter to the customer company B. When the form management server 10 executes transmission of the reminder letter, the execution unit 46 transmits a request for sending the reminder letter to the form management server 10. In response to the request for sending the reminder letter, the form management server 10 creates a reminder letter and sends the reminder letter to the business partner company B. The execution unit 46 further instructs the storage control unit 11 to register the reminder date in the debt management information management DB 4001. The date on which the reminder letter is sent is set as the reminder date.

The communication unit 32 of the debt guarantee server 30 receives the request for debt guarantee service, transmitted by the debt management server 40. At S60, the storage control unit 31 stores the fulfillment information in the fulfillment information management DB 3002 based on the received request for debt guarantee service. At this time, the current date, when the request for debt guarantee service is received, is set as the guarantee request date. Further, the fulfillment status is set to “applying”.

Subsequently, the communication unit 32 transmits an application for the debt guarantee service to the debt guarantee system 4 based on the received request for the debt guarantee. The application for debt guarantee service includes the name of the customer, the billing amount, etc.

At S61, the debt guarantee system 4 registers the application for the debt guarantee service received from the debt guarantee server 30. Thereafter, an auditor who is an employee of the debt guarantee service company F performs audit on the application for debt guarantee service that is registered, and registers the audit result in the debt guarantee system 4. In the above-described audit, the debt guarantee system 4 may automatically check the application for debt guarantee service based on a predetermined condition, and may automatically settle a part or all of the amount of money for which the debt guarantee service has been requested. In other words, any desired method may be used to audit. Then, the debt guarantee system 4 returns the registered audit result to the debt guarantee server 30.

At S62, the communication unit 32 of the debt guarantee server 30 receives the audit result transmitted by the debt guarantee system 4. Next, the storage control unit 31 registers the received audit result in the fulfillment information management DB 3002. Specifically, the storage control unit 31 updates the execution status to “fulfilled” and registers the current date as the fulfillment date.

At S63, the communication unit 32 of the debt guarantee server 30 transmits the received audit result to the user terminal 50. At the user terminal 50, the communication unit 52 receives the audit result transmitted by the debt guarantee server 30. Next, the display controller 51 displays the received audit result on a proposal screen.

Modifications

Display Alert Based on Trend in Transactions

In the information processing system 1 according to the embodiment, when the user presses the apply button 4229 on the proposal screen 4200, application for debt guarantee service is requested to the debt guarantee system 4. At this time, a warning may be displayed based on tendency in transactions by the customer for which the debt guarantee service is applied, before processing application for debt guarantee service to the debt guarantee system 4.

For example, in a case where payment is intermittently delayed in transactions in the last several months, but payment is made thereafter in all cases, it is considered that there is no problem in business operation although the customer tends to miss the payment due date. On the other hand, for example, in a case where a certain customer has always paid before the payment due date in the past transactions but a delay occurs in transactions in the recent month, it is difficult to determine whether the delay is a transient delay or the business operation is in danger.

Such a determination based on tendency in transactions should be made by the user based on comprehensive information. By giving a warning to the user before applying for debt guarantee service, the user is given an opportunity to reconsider, thus preventing unnecessary application for debt guarantee service.

Specifically, after the determination unit 45 determines that the collection action proposed for the debt management information for the uncollected debt is “debt guarantee” (S53-8), the determination unit 45 determines whether or not the transaction history for the particular customer satisfies a predetermined warning rule. If the transaction history satisfies the warning rule, the determination unit 45 outputs information representing the transaction tendency together with the proposed collection action. The information representing the transaction tendency being output is embedded in the screen for displaying the proposal screen by the screen generator 44 (S54).

On the proposal screen 4200, when the apply button 4229 is pressed, a confirmation screen (could be a confirmation window) having an OK button and a cancel button is displayed (S57). When the user presses the OK button on the confirmation screen, a request for debt guarantee service is transmitted to the debt guarantee server 30 (S58). On the other hand, when the user presses the cancel button, the application for the debt guarantee service is canceled, such that no request is transmitted.

Guidance Display of Debt Guarantee Service

In the information processing system 1 according to the embodiment described above, it is assumed that the service user company A has made a contract with the debt guarantee service company F for provision of the debt guarantee service. Further, in the debt guarantee service, it is typical to make a contract to use the debt guarantee service, select a customer as a target of the debt guarantee in advance, and set a range (an upper limit, a guarantee period, and the like) in which the debt guarantee is used for each customer.

Therefore, when the service user company A who is a tenant does not have a contract for the debt guarantee service or when the service user company A having a contract for the debt guarantee service cannot collect the debt for the customer company B who is not a target of the debt guarantee, it is preferable to display a guide prompting the user to use the debt guarantee service.

Proposal Processing

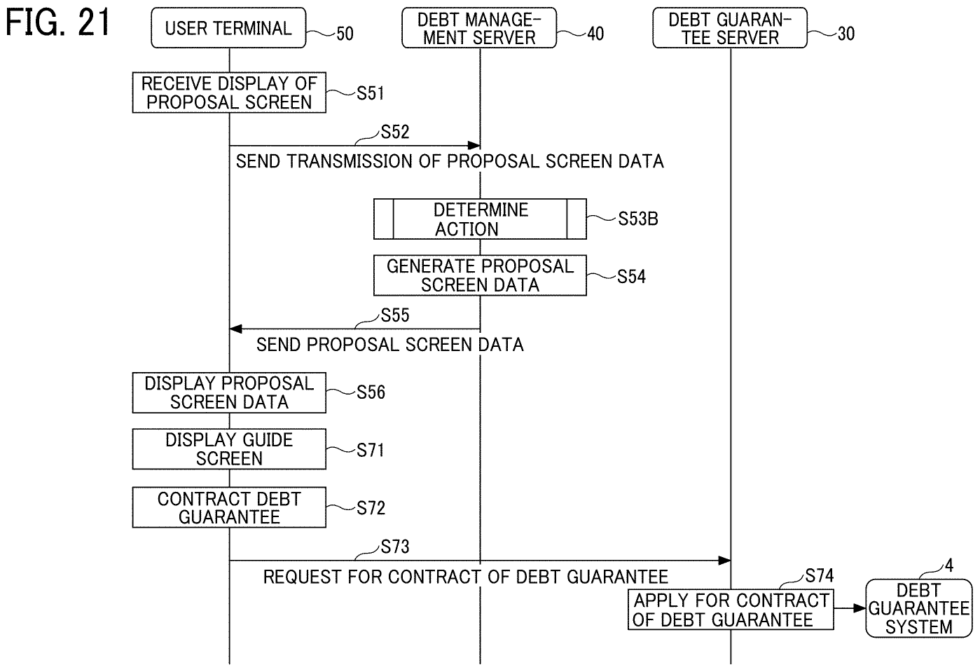

Referring to FIG. 21, the proposal processing is described according to the modified example. FIG. 21 is a sequence diagram illustrating an example of proposal processing according to the modified example. In the following, differences from the proposal processing in the above-described embodiment referring to FIG. 16 will be mainly described.

At S53B, the determination unit 45 of the debt management server 40 determines a collection action to collect the debt with respect to each item of debt management information for the uncollected debt.

Action Determination Processing

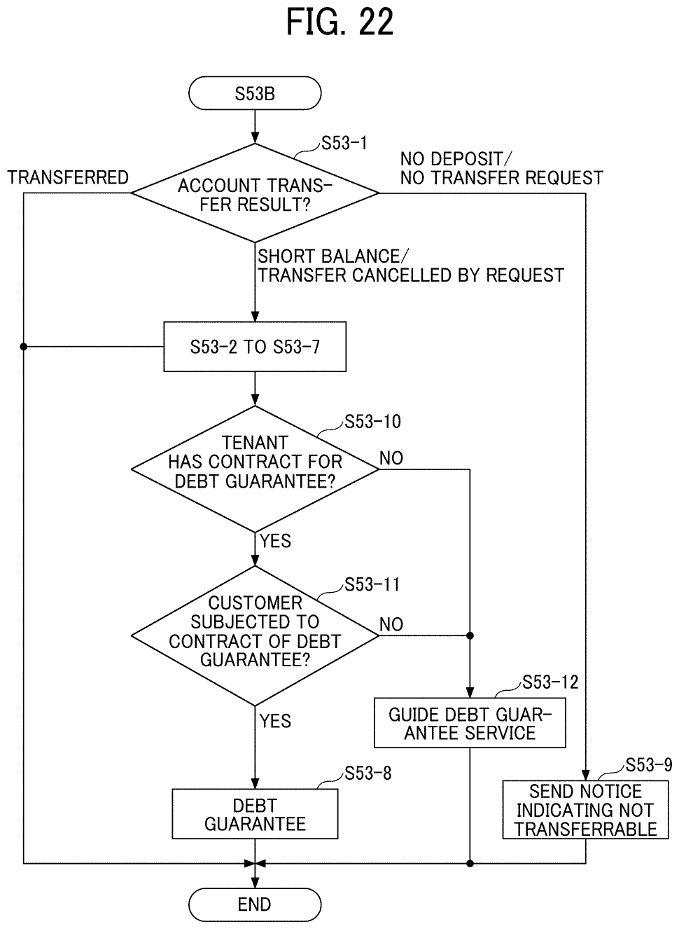

Referring to FIG. 22, action determination processing is described according to the modified example. FIG. 22 is a flowchart illustrating an example of action determination processing corresponding to S53B.

As illustrated in FIG. 22, in the action determination processing according to the modified example, step S53-10 and step S53-11 are executed before executing step S53-8, and step S53-8 or step S53-12 is executed according to the results of step S53-10 and step S53-11.

At S53-10, the determination unit 45 determines whether or not the tenant, who is the user, has a contract for the debt guarantee service. For example, the debt management server 40 stores the service usage status of each tenant. When the user logs in to the transaction management system 2 from the user terminal 50, the debt management server 40 may read out the service usage status related to the debt guarantee service to determine whether or not the tenant has a contract for the debt guarantee service.

When the tenant has a contract for the debt guarantee service (YES), the determination unit 45 proceeds the processing to S53-11. When the tenant does not have a contract for the debt guarantee service (NO), the determination unit 45 proceeds the processing to S53-12.

At S53-11, the determination unit 45 determines whether or not the customer of the debt management information that is selected is a subject of the debt guarantee service. In order to determine whether the customer is a subject of the debt guarantee service, the determination unit 45 may read out the debt guarantee information on a particular customer from the debt guarantee information management DB 3001, and refer to the guarantee status included in the debt guarantee information.

When the customer is a subject of the debt guarantee service (YES), the determination unit 45 proceeds the processing to S53-8. When the customer is not a subject of the debt guarantee service (NO), the determination unit 45 proceeds the processing to S53-12.

At S53-12, the determination unit 45 determines that the collection action proposed for the debt management information is “guide debt guarantee service”

Returning to FIG. 21, description continues. The communication unit 52 of the user terminal 50 receives the screen data for displaying the proposal screen from the debt management server 40. At S56, the display controller 51 displays the proposal screen on the display 506 based on the received screen data.

At S71, the operation input 53 of the user terminal 50 receives an operation of instructing display of the guide screen by the user. The operation of instructing the display of the guidance screen is, for example, an operation of pressing a button included in the proposal screen. Next, the display controller 51 displays the guide screen on the display 506 in response to an operation of instructing display of the guide screen.

Proposal Screen and Guide Screen

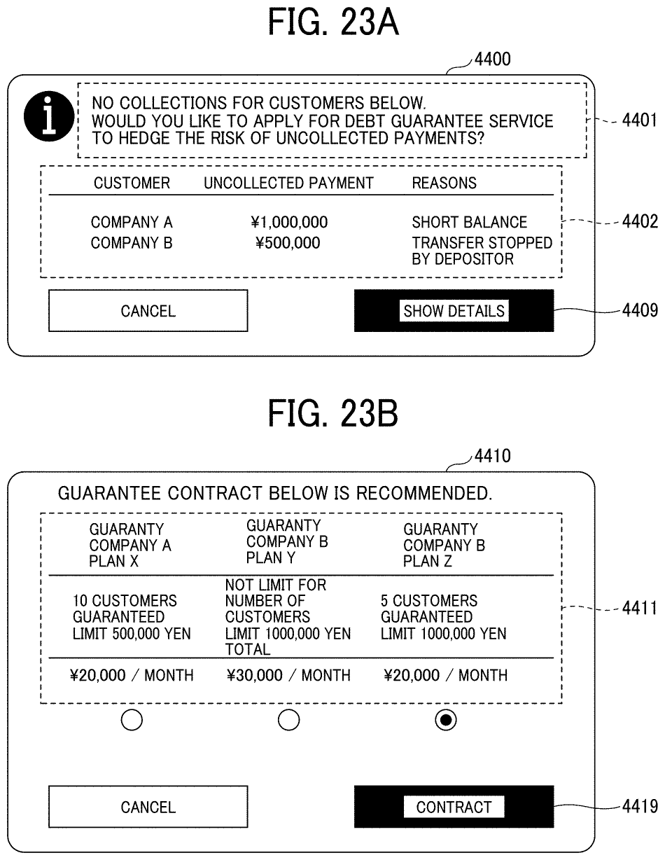

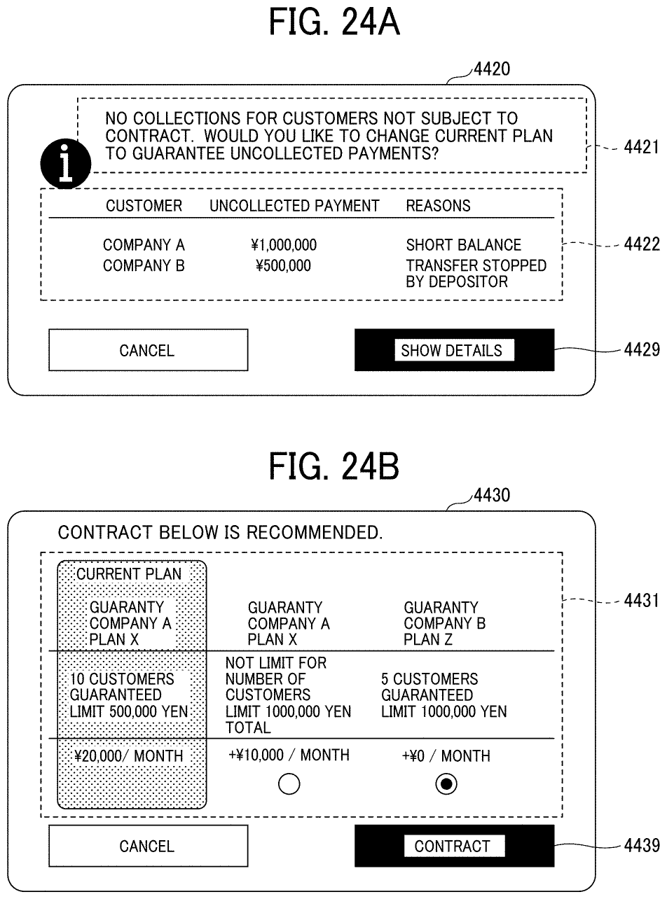

Referring to FIGS. 23A and 23B and FIGS. 24A and 24B, the proposal screen and the guide screen are described according to the modified example. FIGS. 23A and 24A are an illustration of examples of a proposal screen, and FIGS. 24A and 24B are an illustration of examples of a guide screen, according to the modified example.

FIG. 23A is an illustration of an example of a proposal screen 4400 displayed when the tenant does not have a contract for the debt guarantee service. As illustrated in FIG. 23A, the proposal screen 4400 includes a text display field 4401 for displaying text prompting the user to have a contract for the debt guarantee service, a debt display field 4402 for displaying information on uncollected debts, and a detail confirmation button 4409 for displaying a guide screen.

When the operation input 53 receives an operation of pressing the detail confirmation button 4409 by the user on the proposal screen 4400, the display controller 51 displays a guide screen 4410 as illustrated in FIG. 23B on the display 506.

FIG. 23B is an illustration of an example of a guide screen 4410 displayed when the tenant does not have a contract for the debt guarantee service. As illustrated in FIG. 23B, the guide screen 4410 includes a plan display field 4411 for displaying a plurality of plans of the debt guarantee service available to the tenant, and a contract button 4419 for starting processing to have a contract for the selected debt guarantee service.

The plan of the debt guarantee service displayed in the plan display field 4411 is a plan that can be used by the service user company A, from among the plans of the debt guarantee service provided by the debt guarantee service company F affiliated with the service providing company C. When there are many plans available to the service user company A, a predetermined number of optimum plans may be selected in view of the current number of customers of the customer company B or the total amount of debts.

FIG. 24A is an illustration of an example of a proposal screen 4420 displayed when the customer of the uncollected debt is not covered by the current debt guarantee service. As illustrated in FIG. 24A, the proposal screen 4420 includes a text display field 4421 for displaying text recommending extension of plan for the debt guarantee service, a debt display field 4422 for displaying information on uncollected debts, and a detail confirmation button 4429 for displaying a guide screen.

When the operation input 53 receives an operation of pressing the detail confirmation button 4429 by the user on the proposal screen 4420, the display controller 51 displays a guide screen 4430 as illustrated in FIG. 24B on the display 506.

FIG. 24B is an illustration of an example of a guide screen 4430 displayed when the customer of the uncollected debt is not covered by the debt guarantee service. As illustrated in FIG. 24B, the guide screen 4430 includes a plan display field 4431 for displaying a plan currently under contract and a plurality of plans in which a coverage of the debt guarantee is extended, and a contract button 4439 for starting processing to have a contract for the selected debt guarantee service.

Similarly to the case of the plan display field 4411 illustrated in FIG. 23B, the plan in which coverage of the debt guarantee is extended, which is displayed in the plan display field 4431, is selected as an optimum plan, from among the plans available to the service user company A in view of the current number of customers of the customer company B, the total amount of debts, etc.

Returning to FIG. 21, description continues. At S72, the operation input 53 of the user terminal 50 receives an operation of instructing to request a contract for the debt guarantee service by the user. The operation is performed by specifying a particular plan of the debt guarantee service.

At S73, the communication unit 52 of the user terminal 50 transmits a request for applying to have a contract for the debt guarantee service to the debt guarantee server 30 in response to an operation of instructing to have a contract for the debt guarantee service. The request for applying includes information indicating the specified plan.

The communication unit 32 of the debt guarantee server 30 receives the request for applying to have a contract for the debt guarantee service, transmitted by the user terminal 50. At S74, the communication unit 32 transmits the application for the contract for the debt guarantee service, to the debt guarantee system 4 based on the received request for applying. The request for applying includes information on a tenant, information on a customer, information indicating a plan, etc.

According to at least one embodiment described above, based on the debt management information acquired from another server in the transaction management system 2, the debt management server 40 generates a proposal screen that proposes an action for collecting the debt for each uncollected debt, and displays the proposal screen at the user terminal 50. Accordingly, the user at the service user company can easily determine an action for collecting the uncollected debt.

For example, when a plurality of debts is uncollected, it becomes easy to determine which debt should be given priority to apply for the debt guarantee service. Further, even in a case of a debt which has not been collected, if there is a high possibility that payment will be made in the near future based on business operation of the customer, for example, the user may determine to wait for the payment for a while without performing an action for collection.

Furthermore, according to the modified example, in a case where uncollected debt is a debt of a tenant who does not use the debt guarantee service or a debt of a customer who is not covered by the current debt guarantee service, the debt management server 40 generates a guide screen for recommending use of the debt guarantee service and displays the guide screen at the user terminal 50. Accordingly, the user at the service user company is able to analyze one or more options to collect the debt more reliability. Further, the debt guarantee service company is likely to increase a number of requests applying for the contract for the debt guarantee service.

In any one of the embodiments described above, it is assumed that payment is made by account transfer service, but the method of payment is not limited to this example. For example, the payment can be made, at a convenience store using a transfer slip, or using a credit card, etc.

In any one of the embodiments described above, it is assumed that a collection action is proposed for a debt with uncompleted account transfer, but proposal for collection action may be made in any desired situation. For example, when a form such as an estimate or an invoice created by the form management service is sent to the customer, the determination processing described at S53 may be performed on a customer to which the form is transmitted. The user may be warned, in a case where the customer to which the form is transmitted is a customer subjected to the debt guarantee service.

Each of the functions of the above-described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), System on a chip (SOC), graphical processing unit (GPU), and conventional circuit components arranged to perform the recited functions.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

In a first aspect, an information processing apparatus communicably connected to a user terminal operated by a user, includes: an obtainer that obtains a collection status of a debt of a customer to the user: and a communication unit that transmits screen data to the user terminal, the screen data for displaying a proposal screen for promoting the user to select an action for collecting the debt having the uncollected status.

In a second aspect, in the information processing apparatus of the first aspect, the proposal screen includes information on at least one action for collecting the debt of the customer, the at least one action including an action for requesting to apply a debt guarantee service.

In a third aspect, in the information processing apparatus of the second aspect, the obtainer obtains at least one of: account transfer information including a result of account transfer based on the debt: debt guarantee information representing a fulfillment status of the debt guarantee; or credibility information of the customer.

In a fourth aspect, the information processing apparatus of the third aspect further includes a determination unit that determines the action for collecting based on the account transfer information and the debt guarantee information.

In a fifth aspect, in the information processing apparatus of the fourth aspect, the determination unit determines the action for collecting, based on a cause of the account transfer result being uncompleted, and a log of the debt guarantee.

In a sixth aspect, in the information processing apparatus of the fifth aspect, the obtainer further obtains transaction history information indicating an issuance status or a collection status of debt of the customer to one or more other users. The proposal screen may include information indicating a transaction tendency of the customer based on the transaction history information.

In a seventh aspect, in the information processing apparatus of the first aspect, the communication unit transmits screen data to the user terminal, the screen data for displaying a guide screen that displays information relating to the debt guarantee based on a usage status of debt guarantee by the user.

In an eighth aspect, an information processing system including a user terminal operated by a user and an information processing apparatus, which are communicable with each other. The information processing apparatus includes an obtainer that obtains a collection status of a debt of a customer to the user, and a communication unit that transmits screen data to the user terminal, the screen data for displaying a proposal screen for promoting the user to select an action for collecting the debt having the uncollected status. The user terminal includes a communication unit that transmits to the information processing apparatus a request for obtaining the screen data for displaying the proposal screen in response to operation of the user, and a display controller that displays, on the display, the proposal screen based on the screen data transmitted from the information processing apparatus.

In a ninth aspect, an information processing method, performed by a computer communicable with a user terminal operated by a user, includes: obtaining a collection status of a debt of a customer to the user: and transmitting screen data to the user terminal, the screen data for displaying a proposal screen for promoting the user to select an action for collecting the debt having the uncollected status.

In a tenth aspect, in the information processing method of the ninth aspect, the proposal screen includes information on at least one action for collecting the debt of the customer, the at least one action including an action for requesting to apply a debt guarantee service.

In an eleventh aspect, in the information processing method of the tenth aspect, the method further includes obtaining at least one of: account transfer information including a result of account transfer based on the debt; debt guarantee information representing a fulfillment status of the debt guarantee; or credibility information of the customer.

In a twelfth aspect, in the information processing method of the eleventh aspect, the method further includes determining the action for collecting based on the account transfer information and the debt guarantee information.

In a thirteenth aspect, in the information processing method of the twelfth aspect, the determining determines the action for collecting, based on a cause of the account transfer result being uncompleted, and a log of the debt guarantee.

In a fourteenth aspect, in the information processing method of the thirteenth aspect, the method further includes obtaining transaction history information indicating an issuance status or a collection status of debt of the customer to one or more other users. The proposal screen may include information indicating a transaction tendency of the customer based on the transaction history information.

In a fifteenth aspect, in the information processing method of the ninth aspect, the method further includes transmitting screen data to the user terminal, the screen data for displaying a guide screen that displays information relating to the debt guarantee based on a usage status of debt guarantee by the user.

In a sixteenth aspect, a computer program is provided, which causes the computer to perform any one of the above-described method.

In a seventh aspect, a non-transitory recording medium which, when executed by one or more processors, cause the processors to perform an information processing method including: in response to a request from a user terminal of a first user, obtaining a collection status indicating whether collection of an item from a second user to the first user has been completed, determining, for the item having a collection status indicating uncompleted transfer, an action to be taken by the first user to collect the item, and transmitting screen data to the user terminal of the first user, the screen data for displaying a proposal screen including the action to be taken by the first user for selection by the first user.

1. An information processing apparatus comprising:
circuitry configured to
in response to a request from a user terminal of a first user, obtain a collection status indicating whether collection of an item from a second user to the first user has been completed,
determine, for the item having a collection status indicating uncompleted transfer, an action to be taken by the first user to collect the item, and
transmit screen data to the user terminal of the first user, the screen data for displaying a proposal screen including the action to be taken by the first user for selection by the first user.

2. The information processing apparatus of claim 1, wherein the circuitry is configured to
obtain transfer information indicating whether transfer of the item from the second user to the first user has been completed, and a cause of the uncompleted transfer, and
determine the action to be taken by the first user to collect the item, based on the transfer information.

3. The information processing apparatus of claim 2, wherein the circuitry is further configured to
obtain transaction history information indicating a history of transactions by the second user with one or more other users, and
determine the action to be taken by the first user to collect the item, based on the transaction history information.

4. The information processing apparatus of claim 3, wherein the circuitry is further configured to
obtain a transaction tendency of the second user based on the transaction history information, and
determine the action to be taken by the first user to collect the item, based on the transaction tendency.

5. The information processing apparatus of claim 2, wherein the circuitry is further configured to
obtain credibility information of the second user, and
determine the action to be taken by the first user to collect the item, based on the credibility information.

6. The information processing apparatus of claim 1, wherein the item is a debt of the second user to the first user, and the action to be taken by the first user includes an action for requesting to apply a debt guarantee service.

7. The information processing apparatus of claim 6, wherein the circuitry is further configured to
obtain debt guarantee information indicating whether the debt guarantee service has been applied to the second user, and
determine the action to be taken by the first user based on the debt guarantee information.

8. The information processing apparatus of claim 6, wherein
the circuitry is further configured obtain information regarding the debt guarantee service, and
transmit another screen data to the user terminal, the another screen data for displaying a guide screen that recommends the first user to update contents of the debt guarantee service.

9. An information processing system comprising:
the information processing apparatus of claim 1; and
a user terminal comprising another circuitry to
transmit a request for obtaining the screen data for displaying the proposal screen in response to operation of the user, and
display, on a display, the proposal screen based on the screen data transmitted from the information processing apparatus.

10. An information processing system comprising:
circuitry configured to
in response to a request from a user terminal of a first user, obtain a collection status indicating whether collection of an item from a second user to the first user has been completed,
determine, for the item having a collection status indicating uncompleted transfer, an action to be taken by the first user to collect the item, and
display, on a display, a proposal screen including the action to be taken by the first user for selection by the first user.

11. The information processing system of claim 10, wherein the item is a debt of the second user to the first user, and the action to be taken by the first user includes an action for requesting to apply a debt guarantee service.

12. The information processing system of claim 10, wherein the circuitry is configured to
obtain information regarding the debt guarantee service, and
display, on the display, a guide screen that recommends the first user to update contents of the debt guarantee service.

13. An information processing method comprising:
in response to a request from a user terminal of a first user, obtaining a collection status indicating whether collection of an item from a second user to the first user has been completed,
determining, for the item having a collection status indicating uncompleted transfer, an action to be taken by the first user to collect the item, and
transmitting screen data to the user terminal of the first user, the screen data for displaying a proposal screen including the action to be taken by the first user for selection by the first user.

14. The method of claim 13, further comprising:
obtaining transfer information indicating whether transfer of the item from the second user to the first user has been completed, and a cause of the uncompleted transfer, and
determining the action to be taken by the first user to collect the item, based on the transfer information.

15. The method of claim 14, further comprising:
obtaining transaction history information indicating a history of transactions by the second user with one or more other users, and
determining the action to be taken by the first user to collect the item, based on the transaction history information.

16. The method of claim 15, further comprising:
obtain a transaction tendency of the second user based on the transaction history information, and
determine the action to be taken by the first user to collect the item, based on the transaction tendency.

17. The method of claim 14, further comprising:
obtain credibility information of the second user, and
determine the action to be taken by the first user to collect the item, based on the credibility information.

18. The method of claim 13, wherein the item is a debt of the second user to the first user, and the action to be taken by the first user includes an action for requesting to apply a debt guarantee service, the method further comprising:
obtaining debt guarantee information indicating whether the debt guarantee service has been applied to the second user; and
determining the action to be taken by the first user based on the debt guarantee information.

19. The method of claim 18, further comprising:
obtaining information regarding the debt guarantee service; and
transmitting another screen data to the user terminal, the another screen data for displaying a guide screen that recommends the first user to update contents of the debt guarantee service.
